(19) United States
(12) Patent Application Publication
(10) Pub. No.: US 2006/0001569 A1
(43) Pub. Date: Jan. 5, 2006

(54) Radiometric propulsion system

(76) Inventor: Marco Scandurra, Cambridge, MA (US)

Correspondence Address: STANLEY H. KREMEN, 4 LENAPE LANE, EAST BRUNSWICK, NJ, 08816, US

(21) Appl. No.: 11/068,470

(22) Filed: Feb. 22, 2005

Related U.S. Application Data
(60) Provisional application No. 60/521,774, filed on Jul. 1, 2004.

(51) Int. Cl. G01S 3/02; G01K 15/00

(52) U.S. Cl. 342/351; 374/1

(57) ABSTRACT

A highly efficient propulsion system for flying, floating, and ground vehicles that operates in an atmosphere under standard conditions according to radiometric principles. The propulsion system comprises specially fabricated plates that exhibit large linear thrust forces upon application of a temperature gradient across edge surfaces. Several embodiments are presented. The propulsion system has no moving parts, does not use working fluids, and does not bum hydrocarbon fuels.

### CROSS REFERENCE TO RELATED APPLICATIONS

This nonprovisional patent application is a National Stage Entry under 35 U.S.C. § 371 of International PCT Application Number PCT/US 05/02820 filed on Jan. 31, 2005. This application claims the benefit of and priority to this PCT application which, in turn, claims the benefit of and priority to U.S. Provisional Applications Nos. 60/481,999 filed on Feb. 2, 2004 and 60/521,774 filed on Jul. 1, 2004 by the Present Inventor. The Present Application also claims the benefit of and priority to both Provisional Applications. The PCT Application and both Provisional Applications are incorporated it herein in their entirety hereto.

### BACKGROUND

1. Field of the Invention

The field of the invention is concerned with propulsion systems, rarefied gas dynamics, and nanotechnology.

2. Analysis of the Problem and the Prior Art

Propulsion systems for modern aircraft, boats, ships, submarines, and automobiles are based on macroscopic rotary motion of the engine components such as propeller, turbine blades and wheels. These systems, due to the presence of massive gears, shafts and other moving parts, introduce power losses due to friction, slippage, and heat; and reliability problems and maintenance costs related to mechanical wear. Airplane turbines expel hot gases through a nozzle, thereby limiting their use in the global environment for safety reasons. Large moving propeller blades also represent a hazard to people approaching an operating engine. Another disadvantage of a propulsion system based upon macroscopic motion and combustion is the considerable noise and air pollution. Large sums of money are being expended in annual research by private and governmental agencies in the effort to reduce acoustic pollution due to airplane turbines. Noise pollution also forces airlines to spend considerable sums of money to reimburse urban communities adjacent to airports. This translates into increased airfares. Current air propulsion systems also require high power thereby necessitating the use of fossil fuels for hydrocarbon combustion thereby contributing to environmentally dangerous gas emission and global warming. It would be desirable to have a propulsion system having no moving parts, no operational noise, and that would be efficiently powered by electric batteries or fuel cells.

Such an alternative is suggested by a fragile engine called a Crookes Radiometer. FIG. 1 shows a representation of a Crookes Radiometer. This device is comprised of a partially evacuated bulb 1, a pivot 2, and a four winged mill 3 mounted on pivot 2. Each wing or vane is lamp-blacked on one side 4, and silvered on the other side 5. When intense light impinges on the wings the mill starts spinning due to a radiometric force. The motion is completely silent. The method of action of the radiometric force is roughly described as follows. The black surface 4 of each vane becomes hotter than the silvered one 5 because of the different absorption coefficients. The temperature difference generates a force directed toward the colder silver surface as air molecules contained in the vessel impinge on the vanes. In fact, air molecules at low density exert different pressures on hot and on cold bodies. However, the force driving the radiometer is small, of the order of 10⁻⁶ N, and furthermore, at atmospheric pressure the effect vanishes. The present invention addresses and solves these disadvantages. A brief explanation of the driving mechanism of the Radiometer is necessary in order to understand the method of action of the present invention. Such an explanation can be found in more detail in the textbook: “Kinetic Theory of gases”, by L. B. Loeb, 1961 edition, Chapter VII section 84.

At equilibrium air can be considered to be a gas consisting of molecules that are freely moving, point-like particles. Each particle moves with a mean velocity V proportional to the square root of the temperature. Thus molecules move faster and maintain a higher momentum when the air temperature is higher. Molecules bouncing off a hot surface are repelled from that surface at a higher speed than molecules bouncing off a cold surface. Therefore, one would expect molecules to impart a higher momentum to hot surfaces than to cold surfaces. Consequently, the forces on hot surfaces are greater than on cold surfaces. As shown in FIG. 2, in a device having two surfaces 6 and 7, separated by an insulator 8, said surfaces being at two different temperatures: Surface 6 is at temperature T_{c} (cold); Surface 7 is at temperature Tₕ (hot); where Tₕ>T_{c} said device being surrounded by air at temperature T, one should observe a force that pushes the device toward the cold surface. One would expect this force to be proportional to the area of the hot and cold surfaces and to the number of particles present in a unit volume of air. This force would also be expected to be larger at atmospheric pressure than in a partially evacuated vessel. These expectations are contrary to experimental evidence. A thin glass window that is cold on the outdoor surface and warm on the indoor surface will not bend nor break due to this force. The error in the model is in the assumption of freely moving, point-like particles. In the presence of temperature differences and in dense air, collisions between the gas molecules cannot be neglected. After striking the cold surface, a molecule cannot depart quickly from that surface because it is trapped by the surrounding molecules. Therefore, the air above a cold surface is cold, and the air above a hot surface is hot. Furthermore above a cold surface the gas is denser, and the number of molecules striking the cold surface is larger thereby enhancing the momentum imparted to the cold surface. Above the hot surface the gas is less dense, and the number of molecules striking this surface is smaller, thereby reducing the momentum imparted to the hot surface. This effect compensates for the radiometric force. In fact, pressure in the gas equalizes throughout, thereby preventing any significant force from arising outside the Crookes vessel.

If molecules at room temperature could reach the surface and leave it quickly after collision, the radiometric mechanism described above could work in air at standard temperature and pressure. This mechanism however, is only realized when the air is rarefied, and in particular when the molecular mean free path is larger than the size of the surface. The mean free path λ is the average distance that a molecule travels before encountering another molecule. It is given by:

$$λ = \frac{1}{\sqrt{2} π n {σ}^{2}} \qquad [ 1 ]$$

where: σ is the diameter of the molecule; and,
n is the number of molecules present in a unit volume.

Since λ is inversely proportional to the air density, the molecules move almost without collisions at sufficiently small values of n. At these densities, the model of freely moving, point-like particles applies, and the radiometric force is governed by the mechanism described above. A device exploiting this force is Knudsen's Absolute Manometer, a pressure gauge described in section 82 of the book: “The Kinetic Theory of Gases” by L. B. Loeb (Dover, N.Y., 1961). The absolute manometer described therein utilizes the radiometric effect to measure gas pressure in a high vacuum chamber. Here, the force is proportional to the surface area.

The Crookes Radiometer of FIG. 1 also utilizes a rarefied gas environment. However, the pressure inside Crookes vessel is typically of the order of 0.1 mm Hg. Under these conditions the molecular mean free path is about 0.1 mm, while the side b (the linear dimension) of each vane is larger than 1 cm. Therefore, the radiometer works at relatively high gas densities for which the free particle model does not apply. The theory of radiometric forces at these densities was elaborated in the course of intense theoretical and experimental investigations by many authors in a period stretching from 1874 to 1926. It was discovered that the force is in part a shear effect due to thermal creep of air from the cold to the hot surface of the vanes, and is in part a “facial effect” due to a local pressure difference as discovered by Albert Einstein (“Zur Theorie der Radiometerkräfte,” Berlin, July 1924).

Radiometric forces arise in a dense gas when a temperature gradient is present, they are proportional to the intensity of the gradient and they are always directed opposite to it, i.e., toward the cold region. The forces act on small solid bodies—a mean free path wide—immersed in the gas. When a large body is immersed in the gas, only a limited portion (of size λ) of the body is radiometrically active. The unequally heated plates inside Crookes Radiometer provide a simple example. They generate a temperature gradient in the air contained in the vessel. The gradient is stronger at the edge of the plate and therefore the radiometric force is stronger here, as shown in FIG. 3. Here, a vessel 9 encloses a radiometric vane 10, mounted on a pivot 11. The vane is hot on the lower surface 12 and cold on the upper surface 13. Above the central regions of the vane there is a small temperature gradient. However, at the vane edge there is a large gradient 14 due to the proximity of the hot and cold surfaces and this is the active region. This region is enclosed by a phantom line in FIG. 3

J. C. Maxwell first pointed out in 1866 that the radiometric force acts only at the edge of the vane, and that most of the vane surface is inactive (Phil. Trans. Roy. Soc., pp 49-88, London 1866). According to Maxwell, the radiometric forces derive from heat exchange, and are thus more efficient at edges and tips. O. Reynolds and G. Hettner recognized the existence of the flow of molecules from the cold to the hot side of the vane (Phil. Trans. Roy. Soc. Lon., 166, 725, 1876, and Z. Physik, 27, 12, 1924). The flow velocity is linearly dependent on the temperature gradient ∂T/∂x. The flow occurs at the edge of the vane where a strong temperature gradient exists. Associated with this streaming of molecules is a force directed opposite to the temperature gradient. Consider the vane shown partially in FIG. 4. The vane 15 extends in the y-z (facial surface) plane, the thickness L extends along the x (edge surface) direction. The cold facial surface 16 is kept at low temperature T_{c} and the hot facial surface 17 is kept at high temperature Tₕ such that (Tₕ−T_{c})=ΔT. The creep force 19 pushes edge surface 18 in the direction shown, such force is opposite to the flow 20. A formula for this force can be found in section 82 of the book: “The Kinetic Theory of Gases” by L. B. Loeb (Dover, N.Y., 1961) as quoted from the article by Hettner et al. and it is given below in terms of the parameters relevant for the present invention, namely the molecule average diameter a the molecule density n and the thickness of the vane L:

$${F}_{creep} = - \frac{3}{4 \sqrt{2} {π}^{2}} \frac{k}{{σ}^{2}} \frac{Δ T}{L} {S}_{v} \qquad [ 2 ]$$

where k is the Boltzmann constant and Sᵥ is the area of surface 18 shown in FIG. 4. The creep force is proportional to the surface of the vane which is parallel to the temperature gradient.

Thermal creep, also called thermal transpiration, was first observed by O. Reynolds (Phil. Trans. Roy. Soc. Lon. 1876), and was used by him to generate a pressure difference between two chambers containing gases kept at different temperatures. The chambers were separated by a thick porous plug made of stucco or Meerschaum. Such a plug or membrane comprises long channels having a very small diameter. The gas contained in the cold chamber moved by creeping along the channels toward the hot chamber. The flow was very slow, but Reynolds achieved a measurable pressure differential between the two chambers when the temperature difference was of the order of one-hundred degrees Fahrenheit. This effect was exploited by several inventors to fabricate vacuum pumps. One of the latest is a micro pump patented under U.S. Pat. No. 6,533,554. This device utilizes a silica aerogel membrane as a porous plug. Aerogel membranes have a channel-like structure with a channel diameter smaller than the mean free path of air at atmospheric pressure. The aerogel also has a low thermal conductivity which helps to insulate the two chambers. This device produces a low gaseous flow with the remarkable advantage of having no moving parts. Recently the use of a thermal transpiration pump as a part of a micro-scale propulsion system was proposed by F. Ochoa, C. Eastwood, P. D. Ronney, and B. Dunn (“Thermal Transpiration Based Microscale Propulsion and Power Generation Devices,” 7th International Microgravity Combustion Workshop, Cleveland, Ohio, June 2003). They disclose a thermal transpiration pump very similar to the one used in the above mentioned patent. The pump is utilized to compress reactants before combustion in a combustion chamber in order to obtain thrust. This microscale propulsion system has the advantage of no moving parts. However its disadvantages include the following:
1. Use of combustion of hydrocarbons to drive the compressor, as in conventional turbine propulsion, with consequent production of hot hazardous gases to be ejected by a nozzle.
2. Emission of pollutant gases.
3. The large thickness of the membrane prevents generation of large creep forces. Aerogel sheets below 0.1 mm thickness are difficult to fabricate and would be too fragile to sustain stresses and pressure differentials.
4. Operational temperatures of several hundred degrees Kelvin above room temperature are necessary to obtain usable forces.
5. The device produces a very limited thrust and features a small thrust/weight ratio.

There is also another reason for the existence of radiometric forces. It was discovered by A. Einstein in 1924 (previously cited; see also L. B. Loeb, section 84 where Einstein's original paper is almost entirely translated). Einstein found that radiometric forces also act on surfaces normal to the temperature gradient, i.e., on facial surfaces, 16 and 17, as shown in FIG. 4. Einstein's forces act on a tiny portion of the facial surfaces, said portion being only a mean free path wide. Einstein's approach is to consider an infinitely thin vane as shown in FIG. 5. Here, an ideal radiometer vane 21, with arm 22 is shown. According to Einstein, the tiny strip 23 delimited by the phantom line is the active area of the vane. The width of the strip is approximately λ. Einstein's theory can be summarized as follows. When a large infinitely thin plate is immersed in a region of air where a temperature gradient ∂T/∂x exists, the pressure is constant in the column of air above the center of the plate—i.e., the quantity nT is a constant. This is empirically observed. Away from the plate, where no object is present, one observes that the air does not move. Therefore the mass motion of the air must be zero, and the quantity \sqrt{nT} is a constant. This quantity and the quantity nT cannot be mathematically constant at a same time. Thus, as Einstein points out, far away from the plate there is a net momentum flow, i.e. molecules coming from the hot side carry more momentum than molecules coming from the cold side. The molecules from this region impinge obliquely on the facial edge of the plate exerting a net force. In other words, at the edge of the plate, there exists a transition region (23 in FIG. 5) of the size of the mean free path λ in which there is a pressure differential. The pressure is higher on the side of the plate facing the higher temperature. A strip of width λ on the facial surface of the plate will thus experience a higher pressure from molecules impinging obliquely from the hot side of the gas. The net force is proportional to the perimeter of the plate and can be easily calculated by kinetic theory of gases and is given by:

$${F}_{Einstein} = - \frac{1}{2} p \frac{{λ}^{2}}{T} \frac{\partial T}{\partial x} ℓ \qquad [ 3 ]$$

where l is the perimeter of the plate and p is the average gas pressure. This force acts on surfaces normal to the temperature gradient (facial surfaces).

Einstein calculates the force for the case of a plate which is hot on one side and cold on the other (as in Crookes radiometer) by inserting into equation [3] the following gradient

$$\frac{\partial T}{\partial x} = \frac{{T}_{h} - {T}_{c}}{λ} \qquad [ 4 ]$$

In reality, Einstein's model uses a plate with no thickness, and thus the gradient would be infinite. However Einstein assumes that λ is the minimum effective thickness and therefore, equation. [4] yields the maximum effective gradient. The force does not increase for L<λ. Furthermore, the concept of temperature is meaningless below the mean-free-path dimension. As a consequence of this, Einstein finds a radiometric force:

$${F}_{Einstein} = - p λ \frac{{T}_{h} - {T}_{c}}{T} ℓ \qquad [ 5 ]$$

Equation [5] explicitly shows the linear dependence of the force on the perimeter l. This dependence was experimentally verified by Marsh, et al. (J.O.S.A. & R.S.I., 11, 257, 1925 and JOSA & RSI, 12, 135, 1926). In these experiments the radiometric force was measured for two kinds of plates shown in FIG. 6. The first, a regular plate, similar to a Crookes vane, is shown in FIG. 6 as element 24 (top view). The second plate 25 has a larger perimeter with a surface area equal the surface area of the plate 24. The plates were illuminated on the lamp-blacked side and the force was measured by means of a torsion pendulum. It was found that for the plate with the larger perimeter 25 the force was larger than that for the plate with the smaller perimeter 24. Einstein's equation [5] was qualitatively verified with reasonable accuracy—the discrepancies being attributed to the difficulty in measuring and maintaining the temperature gradient in the perforated plates.

The idea of perforating the plate as in FIG. 6, with the goal of increasing the perimeter and thus the force, was exploited by inventor Marc S. Paller (U.S. Pat. No. 4,397,150, Aug. 9, 1983). Paller discloses a lattice of strips used in a radiometric light-mill within a partially evacuated vessel. The perforated vane produces a higher rotational speed of the mill. The goal of the invention is to convert radiant energy, (necessary to maintain the temperature gradient) into rotational kinetic energy, and then into electrical energy. The gas to be contained in the vessel is possibly helium due to its small molecular size and large mean free path. The disadvantage of this apparatus is the need for a vessel containing a controlled gas type and density. It is a device that requires a selection of gas type and gas conditions in order to fit the device specification. It would be desirable to have a radiometric device that adapts to the natural occurring conditions of air at atmospheric pressure. It would also be desirable to have a radiometric device that produces a linear thrust rather than a rotational force on a carefully balanced rotational assembly—a thrust that is large enough to provide propulsion for vehicles. Generation of linear thrust is not the goal of the above mentioned invention by Paller.

### DEFINITIONS OF SPECIAL TERMS

In preparing this patent application, the Applicant uses technical terms, although for which there exist ordinary meaning and usage, special definitions are provided herein. These special definitions supersede the ordinary meaning and usage of the following terms:
Vane—one of a plurality of members of the mill of a Crooke's radiometer.
Radiometric—pertaining to the physical principles that govern movement of a Crooke's radiometer.
Plate—(or Radiometric Plate)—a device capable of experiencing radiometric forces. A vane is a specific type of plate. However, in the general case, a plate need not be part of a Crooke's radiometer.
Radiometric Drive—a device comprising at least one plate having apertures and immersed in a fluid medium of molecules such that the minimum dimension of the apertures and the thickness of the plate is of the order of the mean free path of the molecules of the fluid medium. A radiometric drive is capable of exerting large radiometric forces upon the application of a temperature gradient.
Membrane—a surface of a radiometric plate. A radiometric plate is an assembly that comprises essentially parallel membranes separated by an insulator which may be a gas, a solid, and/or a liquid.
Radiometric Material—a material suitable for use in the fabrication of a membrane.
Thruster—(or Radiometric Thruster)—an assembly comprising a radiometric plate (i.e., essentially parallel membranes separated by an insulator), electric heat pumps, and a power source. A thruster is the smallest independent element capable of providing propulsion.
Module—an assembly comprised of a multiplicity of thrusters. A single power source may be shared between the thrusters comprising the module. The module may also comprise structurally reinforcing beams.
Generic Cooler—an electric heat pump of any kind that generates a useable temperature gradient.
Radiometric Propulsion System—an assembly comprising at least one module wherein a radiometric force is used to produce motion.
Mean Free Path—denoted by the Greek Letter λ—is the average distance that a molecules travels unperturbed between two consecutive collisions.
The Order of λ—is the mathematical product obtained by multiplying λ (the mean free path) by a real number that must be determined through experimentation. The order of λ is the exact empirical value for the size and thickness of the radiometric components which differs from Einstein's Theory which only produces an approximation.

### BRIEF DESCRIPTION OF THE DRAWINGS

FIG. 1 is a schematic drawing of Crookes' Radiometer, a device well known in the art.

FIG. 2 is a schematic of a device having two surfaces at different temperatures and separated by an insulator.

FIG. 3 is a schematic drawing of a partially evacuated vessel containing a pivot and a radiometer vane which generates a temperature gradient.

FIG. 4 is a three-dimensional view of a plate having two surfaces at different temperatures, and showing the creep force.

FIG. 5 is a representation of an infinitely thin Crookes Radiometer vane.

FIG. 6A is a representation of the lamp-blacked surface of a Crookes Radiometer vane shown in FIG. 4;

FIG. 6B is a representation of the lamp-blacked surface of an experimental plate that has a larger perimeter than and the same surface area as the previous plate.

FIG. 7 is a representation of a radiometric plate that has holes arranged in a rectangular matrix.

FIG. 8 is a representation of a radiometric plate that has holes arranged hexagonally close packed.

FIG. 9 is a representation of a radiometric plate fabricated from parallel strips of material.

FIG. 10 is a three-dimensional representation of a section of the radiometric plate shown in FIG. 7.

FIG. 11 is a partial section of a radiometric plate consisting of two parallel perforated membranes and an insulating layer, the insulating layer being possibly air.

FIG. 12 is a schematic representation of the process flow for the fabrication of two thin, parallel perforated membranes using micro- and nano-fabrication technology. The process is described in five steps that are shown schematically in FIG. 12A through FIG. 12E.

FIG. 13 is a front view of a radiometric thruster comprising a radiometric plate and two Peltier couples as the first embodiment of the present invention.

FIG. 14 is a top view of the thruster shown in FIG. 13

FIG. 15 is a left-side view of the thruster shown in FIG. 13.

FIG. 16 is a left-side view of a thruster comprising superlattices Peltier coolers

FIG. 17 is a front view of a thruster similar to the one shown in FIG. 13 having a radiometric plate built close to the level of the hot junctions.

FIG. 18 is a front view of a thruster similar to the one shown in FIG. 13 having a radiometric plate built close to the level of the cold junctions.

FIG. 19 is a front view of a thruster similar to the one shown in FIG. 13, having solid spacers sandwiched between the radiometric membranes as the second embodiment of the present invention.

FIG. 20 is a front view of a radiometric thruster using thermionic- and/or thermotunnel-based electric coolers also called thermionic- and/or thermotunnel diodes or converters as the third embodiment of the present invention.

FIG. 21 is a top view of the radiometric thruster shown in FIG. 20.

FIG. 22 is a top view of a radiometric module featuring a large radiometric plate and multiplicity of thermoelectric Peltier coolers connected in series electrically and in parallel thermally as the fourth embodiment of the present invention.

FIG. 23 is a left-side view of the radiometric module shown in FIG. 22.

FIG. 24 is a top view of a radiometric module with simple electric connections between rows of thermoelectric Peltier couples.

FIG. 25 is a partial left-side view of a radiometric module with thermoelectric coolers directly sandwiched between the radiometric membranes as the fifth embodiment of the present invention.

FIG. 26 is a partial front view of the module shown in FIG. 25.

FIG. 27 is a radiometric module comprising a multiplicity of thermionic- and/or thermotunnel-coolers connected in series electrically and in parallel thermally as the sixth embodiment of the present invention.

FIG. 28 is a partial left-side view of the radiometric module shown in FIG. 27.

FIG. 29 is a radiometric module with thermionic- and/or thermotunnel-coolers directly sandwiched between the radiometric membranes as the seventh embodiment of the present invention.

FIG. 30 is a partial front view of the radiometric module shown in FIG. 29.

FIG. 31 is a partial front view of a beam-reinforced radiometric module with generic coolers as the eighth embodiment of the present invention.

FIG. 32 is a larger portion of the front view of the radiometric module shown in FIG. 31.

FIG. 33 is a top view of the larger portion of the device shown in FIG. 32.

FIG. 34 shows a method of connecting several beam-reinforced radiometric modules.

FIG. 35 is a partial front view of a reinforced radiometric module with generic coolers directly sandwiched between the radiometric membranes as the ninth embodiment of the present invention.

FIG. 36 shows a front view of a device comprising two or more radiometric modules stacked one above the other as the tenth embodiment of the present invention.

FIG. 37 shows the use of a large, reinforced radiometric module in a VTOL vehicle.

FIG. 38 shows the use of a large, reinforced radiometric module in a ground vehicle.

FIG. 39 shows the use of a large, reinforced radiometric module in a floating vehicle.

### DETAILED DESCRIPTION OF THE INVENTION

The present invention is a propulsion system that produces increased radiometric forces for use in powering the motion of ground and air vehicles. These increased forces are produced without the need for a low pressure environment. In other words, this system produces usable forces suitable for propulsion of vehicles as well as for other applications in air under standard atmospheric conditions.

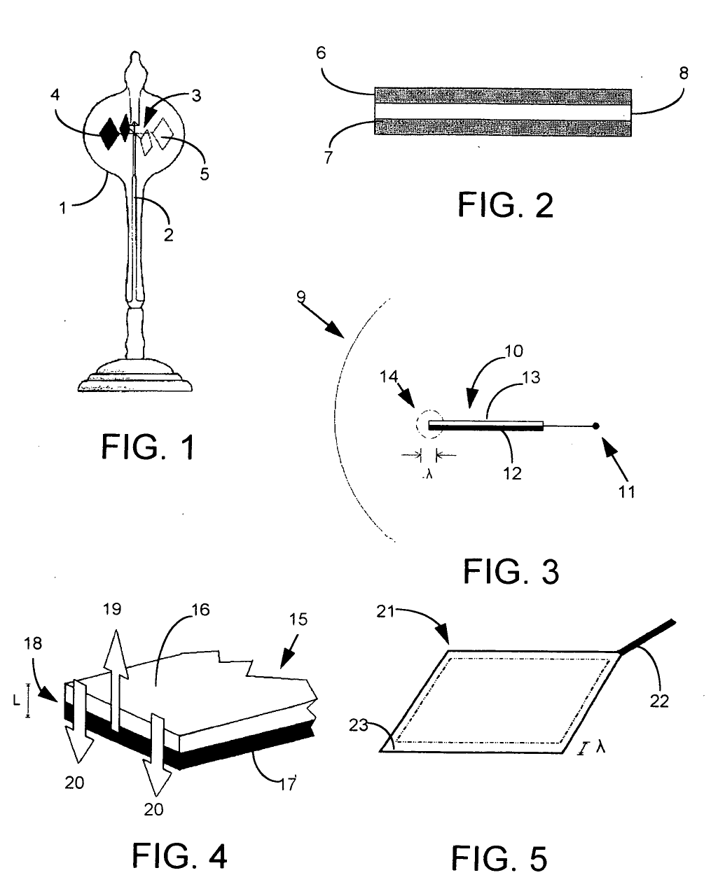

The Crookes Radiometer of FIG. 1 has a mill 3 that rotates on pivot 2. The mill is comprised of four vanes that are essentially flat plates. The application of the present invention is not necessarily the rotation of a mill. Nonetheless, radiometric forces act on the plates that are used in the present invention. Therefore, the more general term “plates” will be used throughout to describe the vanes of the Crookes Radiometer as well as the plates used in the present invention.

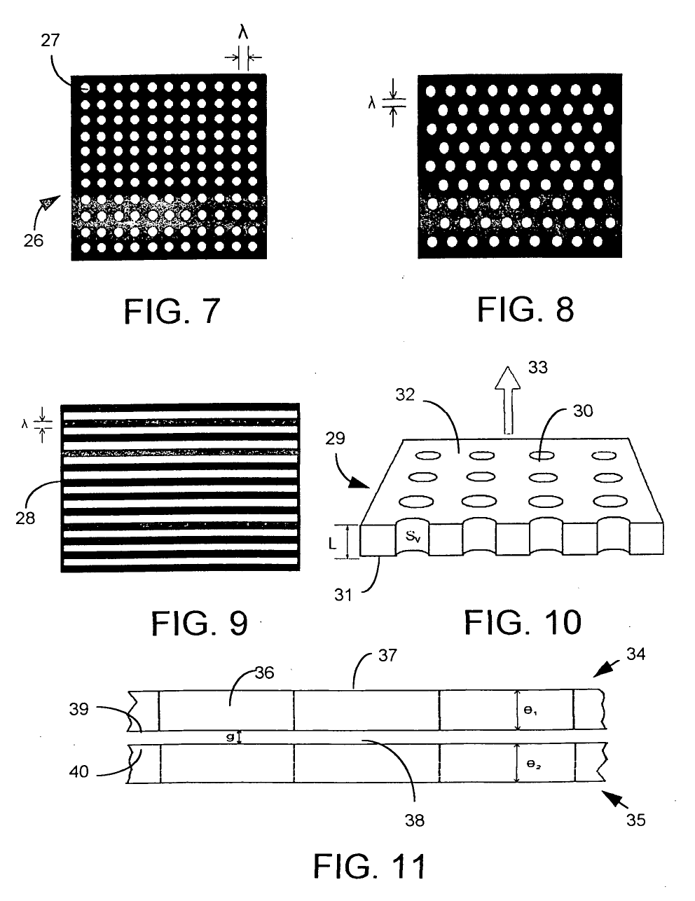

According to theory, the radiometric forces are given by equations [2] and [5]. These equations show that the forces depend on the perimeter of a plate rather than on the surface area. Equation [5] shows this dependence explicitly, while equation [2] is proportional to the edge surface Sᵥ which in turn is a linear function of the plate perimeter. Therefore, if one could increase the perimeter of the vanes, one would enhance the force inside the radiometer. This was experimentally proved by Marsh et. al in 1926, as described above. However, if increasing the perimeter also increases the surface area of the vanes, then the size and weight of the device could become unmanageable with no enhanced usability for the larger surface. Therefore, it is not advisable to simply increase the linear dimension of a plate. A better way to increase the perimeter would be to perforate the plate with a pattern of apertures. This is shown schematically in FIG. 7. The surface 26 of the plate has a large number of holes 27 of arbitrary shape (not necessarily circular as shown in the figure). The force is maximized using this geometry when the surface width between the holes is of the order of the molecular mean free path of the medium in which the plate is immersed, i.e., λ. In fact, Einstein's theory predicts that only strips as wide as λ or smaller are active. However, Einstein's theory is based on an approximation. Therefore, when referring of the order of λ anywhere in this document, the mathematical quantity xλ is intended, where x is a real number. The number x must be found empirically. Were the average distance between the apertures to be larger than the order of λ, portions of the surface would be inactive. The surface defined by the material between the apertures is called the closed surface. In theory, holes of diameter xλ, spaced apart so as to occupy approximately 50% of the entire surface area would greatly enhance the force. The radiometric effect is caused by the presence of a transition region between closed and open spaces. Therefore, large open spaces should be avoided, and large, uninterrupted closed surfaces should be avoided as well. An equal distribution of open and closed spaces should generate a transition region extending over the entire area of the plate. Consequently, the open area of the plate should be of the order of 50%, and the closed surface area should also be of the order of 50% of the total. With this geometry, the entire closed surface of the plate would be radiometrically active. The linear dimension of that portion of the surface between the apertures can be smaller than λ provided that the open area remains of the order of 50%. No element of the theory suggests that a different percentage of open area would be more effective. However, the optimal percentage of closed surface for force enhancement should be found empirically and could be less or more than the theory predicts.

FIG. 7 is a representation of a radiometric plate with closed surface 26, that has holes 27 arranged in a rectangular matrix. The distance between the holes is the order of λ. FIG. 8 shows a geometry where the holes are positioned hexagonally close packed relative to each other. Square apertures could be implemented instead of circular ones in FIG. 7. In this case, the plate would appear as a matrix of orthogonal strips of width and spacing of the order of λ. Width can differ from spacing. Square apertures could also be implemented in a hexagonal matrix similar to the one shown in FIG. 8. FIG. 9 shows another geometry that involves fabricating the plates from parallel strips of material, 28, where the width of each strip is of the order of λ, and the spacing between the strips is also of the order of λ. Width can differ from spacing. The open area is 50% of the total area unless a different percentage is found to be more effective empirically. This geometry can be easier to realize.

In order to operate in air at atmospheric pressure, where λ≈70 nm, in a propulsion system comprising plates having holes or apertures as shown in FIG. 7, 8, or 9, the size of the apertures would be of the roughly of the order of 70 nm or less. This is within the reach of existing nano-fabrication technology. Arrays of holes having diameters as low as 10 nm can be realized with alumina templates. Other nano-lithographic techniques are applicable, including electron beam lithography, interference lithography, self assembly of block copolymers, zone-plate lithography, X-ray lithography and soft-imprint lithography. The parallel strip geometry of FIG. 9 can be realized by the same techniques. In the Nanostructures Laboratory of the Massachusetts Institute of Technology, matrices of nano-holes with periods of 100 nm on free-standing silicon nitride plates are routinely realized by interference lithography combined with reactive-ion etching. Such plates are used in X-Ray spectroscopy. Each of the above mentioned techniques—which are known to anyone skilled in nano-engineering technology—can be used either individually or combined with other techniques for fabricating the present invention.

The present propulsion system applies a temperature gradient across a nano-perforated plate in air at atmospheric pressure. The resultant force can be directly used to provide linear thrust to a vehicle. In particular, if the plate is positioned horizontally with the cold side facing up, the force will lift the vehicle vertically, as shown in FIG. 10. This is a frontal section of a radiometric drive. Here, the plate 29 has a thickness L of the order of 70 nm. The plate has an array of holes or channels, 30, with spacing and possibly (but not necessarily) diameter equal to the order of 70 nm. In this geometry, the thickness is equal to the spacing. Aperture diameter and thickness are of the order of λ. The temperature Tₕ of the lower surface 31 is higher than the temperature T_{c} of the upper surface 32. Therefore, the plate would experience an upward lift force 33.

The following discussion estimates the thrust provided by the present invention in air at atmospheric pressure for a temperature difference of Tₕ−T_{c}=1° K.

Einstein's force given in Equation [5] can be rewritten in the form:
F_{Einstein}=−nk(Tₕ−T_{c})(λl) [6]
since, according to Boyle's Law, p=nkT. The quantity λ×l inside the parenthesis in Equation [6] is what we defined above as the closed surface. Equation [6] can be rewritten in the compact form:
Fₕ=−nk(Tₕ−T_{c})Sₕ [7]
where Sₕ is the closed surface, and the subscripts h refer to the fact that the force acts on the facial surface (oriented horizontally in the previous figures) of the plate as discussed in the BACKGROUND section (above). In the case of a closed surface equal to 50% of the total area A of the plate (where A=closed surface area+open area), the Einstein force per unit area of the plate is given by:

$${P}_{h} = - \frac{1}{2} nk ( {T}_{h} - {T}_{c} ) \qquad [ 8 ]$$

Let us calculate the creep force acting on a perforated plate of thickness L=λ. With the help of Equation [1], Equation [2] can be rewritten as:

$${F}_{v} = - \frac{3}{4 π} nk ( {T}_{h} - {T}_{c} ) {S}_{v} \qquad [ 9 ]$$

The edge surface Sᵥ, is a function of the thickness L, the plate side b, the number of apertures j, and the perimeter f of a single aperture, according to the following equation:
Sᵥ=4bL+jfL [10]

The surface Sᵥ can be large, provided that there are a large number of apertures. In the case where the apertures are circular with a radius R and with a 50% open surface, the force per unit area A of the plate is:

$${P}_{v} = - \frac{3}{4 π} nk ( {T}_{h} - {T}_{c} ) \frac{λ}{R} \qquad [ 11 ]$$

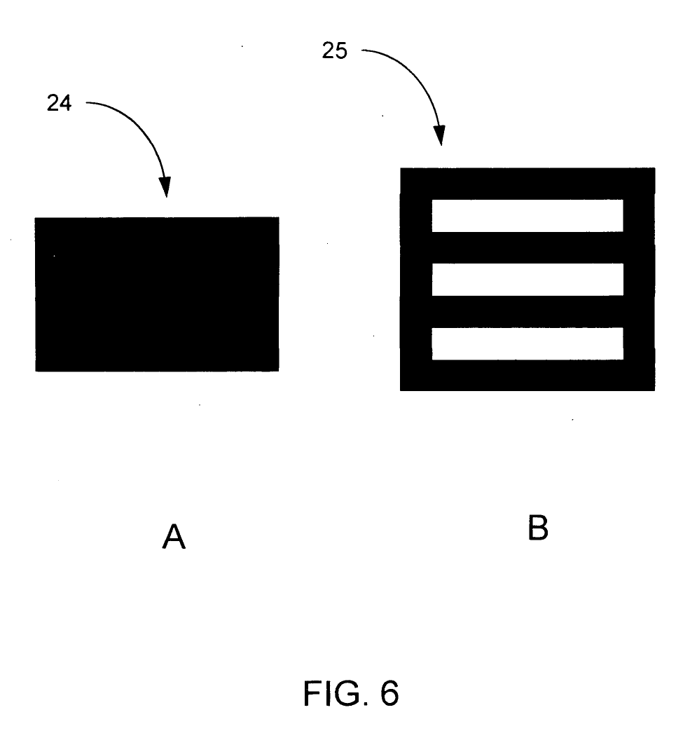

The total force P per unit area A of the plate shown in FIG. 6, is given by the sum of Pₕ and Pᵥ.

$$P = ( \frac{1}{2} + \frac{3}{4 π} \frac{λ}{R} ) nk Δ T \qquad [ 12 ]$$

At atmospheric pressure:
n≈2.5×10²⁵ m⁻³
k=1.38×10⁻²³ J/° K
For R=λ/2, the force derived from Equation [12] is approximately equal to 0.034 Newton per square centimeter for a temperature difference of one degree Kelvin.

Equations [6], [7], and [8] are valid when the temperature gradient is given by Equation [4]. Thus the thickness, L, of the plate should be small, preferably of the order of λ. Were the thickness to be larger than the order of λ the temperature gradient would be smaller, and consequently, the force would also be smaller. Conversely, there would be no advantage to decreasing the thickness of the plate to less than the order of λ, since this is the minimum effective thickness. A perforated plate, like the one in FIG. 10 will have air streaming through its channels directed from the cold surface toward the hot surface. Because of the small thickness of the plate, the streaming of the air is not impeded by drag along the channel walls. Thermal creep theory predicts that only a portion of the order of λ of the cylindrical walls of the channels is active in accelerating the gas. Longer channels would have inactive portions of surface and would increase the drag according to the laws of gas flow through capillary tubes (Poiseuille Law). Furthermore, were the thickness of the plate larger than the order of λ, a larger temperature difference would be necessary to generate usable gradients. The minimum effective channel length is the order of λ. Thus, in theory, the thermal creep force is maximized when the plate thickness is of the order of λ. The plate thickness is a crucial factor for maximizing radiometric forces due to both Einstein's effect and thermal creep.

The present invention, an electric propulsion system for vehicles, would have no moving parts. In particular, it would not depend upon rotary motion of shafts, wheels or propellers. The vehicle should only be equipped with a mechanism for maintaining the temperature gradient and a steering mechanism. This propulsion system would be a valid substitute for the rotor blades and engine of a helicopter or any other vertical take of and landing (VTOL) aircraft. In particular, a radiometric plate positioned horizontally would provide a levitating force, while radiometric plates positioned vertically would provide translatory motion to such an aircraft. A practical application would require multiple radiometric plates to provide thrust in multiple directions (e.g., vertical and horizontal).

Another application of the present invention would be in ground vehicles. A car weighing 1500 Kg and accelerating from 0 to 100 Km/hr in 10 seconds requires an average force of about 4,000 Newton (friction is neglected in this estimate). This could be provided by the radiometric propulsion system of the present invention comprising a perforated plate having a surface area of one square meter and with a temperature difference of twelve degrees Kelvin. The plate would be positioned perpendicular to the direction of motion of the car, and it should not have any obstacles behind it. The cylindrical axis of the holes would be parallel to the direction of motion.

Crucial to implementation of the propulsion system of the present invention is the maintenance of the temperature gradient across a thin radiometric plate. The hot surface is insulated from the cold one by means of one or more layers of thermally insulating materials sandwiched between the surfaces. In the preferred embodiment, a thin layer of air is sandwiched between the hot and the cold surfaces as shown in FIG. 11. Here, a partial section of a radiometric plate is shown. Two parallel membranes 34 and 35 are visible. The membranes have holes 36 spaced apart by solid material 37. An air layer 38 is sandwiched between the membranes. Air provides the best possible insulation and permits significant temperature differences to be achieved. The total thickness L is the sum of the two thicknesses θ₁ and θ₂ of the membranes and the air layer g shown in FIG. 11. Note that the thicknesses of the membranes may be different or equal. The thickness L is of the order of λ. It is to be noted that the internal surfaces 39 and 40 of the parallel membranes do not contribute to the radiometric forces. While air is preferred as an insulator any insulating material of any thickness can be sandwiched between membranes 34 and 45. In the case of a solid insulator, the insulating layer will have holes of the same diameter and spacing of the holes of the membranes. The holes of the insulating layer will be aligned with the holes of the membranes. In the following discussions, we will refer to the assembly comprising the parallel membranes and the insulator (gaseous, solid or mixed insulator) as the radiometric plate. And each of the perforated membranes 34 and 35 will be referred to as the radiometric membrane.

The thermal and mechanical stresses involved in the fabrication and in the use of the radiometric plate places constraints on the choice of materials appropriate for this invention. The radiometric membranes shown in FIG. 11 should efficiently conduct heat longitudinally. However, in view of the integration with an electric circuit, it would be desirable to have membranes that poorly conduct electric currents. Furthermore, the membranes should have the highest possible Young modulus to withstand mechanical stresses. A material should meet these requirements in the form of thin films rather than bulk. The material should also be chemically and thermally stable. After materials with these properties are found, a further constraint derives from the ability to deposit high quality nano-crystalline layers of such materials and to integrate such layers in a system. In the following we will refer to any material with these properties as radiometric material. For the fabrication of the radiometric membranes the following materials are preferred: silicon carbide (SiC), diamond-like carbon (C), aluminum nitride (Al N), silicon nitride (SiNₓ) and tungsten (W). Other materials not included in this list might be used as long as they satisfy the properties mentioned above. New materials currently being investigated, such as nano-composites or polymers might be utilized in this application. According to experiments performed by Martin Knudsen and elucidated in Annalen der Physik, 5, 6, pg. 129, 1930, if the hot and cold membranes of a radiometric plate have different accomodation coefficients, a, and a₂, the radiometric force can be enhanced. The additional force is proportional to the difference between the accomodation coefficients (a₂−a₁). Thermal transpiration calculations and Einstein force calculations used previously in this disclosure implicitly assume the accomodation coeffient equal to unity. Therefore, in this invention, the membranes can be fabricated from two different materials (possibly radiometric materials) having different accomodation coefficients.

The small thickness of the radiometric plate poses structural problems. Large, free standing radiometric plates of 70 nm thickness cannot be fabricated. Such plates would be too fragile to sustain their own weight and the radiometric pressure.

Furthermore, a limited bending under stress is tolerated in the configuration of two parallel membranes shown in FIG. 11. Here, a contact between membranes, 39 and 40, would result in a large heat transfer at the point of contact and a consequent ΔT loss. Bending will be triggered by the radiometric force and by the attractive Van der Waals forces between the membranes. Calculations show that a 30 nm thick, 4 μm wide SiC membrane would bend at the center by 1 nm when a ΔT of 3° K is applied. This prediction is justified in the following: A lattice of crossing orthogonal beams can be used as a model for a perforated membrane in this calculation. The beams all have identical thickness θ, length b and width w. The pressure present on the lattice due to the radiometric forces can be calculated by means of Equation [12]. For a ΔT=3° K, recalling that the force acts also on surfaces parallel to the gradient, the radiometric pressure amounts to roughly 3000 Pascal (pa). The Van der Waals force of attraction is calculated by means of the formula:

$${F}_{VW} = \frac{{HS}_{h}}{6 π {g}^{3}} \qquad [ 13 ]$$

Where H is the Hamaker constant of the material;
Sₕ is the closed surface; and,
g is the membrane separation.

Values of Hamaker constant are in the range 10⁻²⁰ to 10⁻¹⁹ Joule. The exact value of the Hamaker constant for materials like silicon carbide is unknown in the literature. Using a value of H=6.6·10⁻²⁰ J (Hamaker constant for fused silica) and g=10 nm, one finds a force per unit surface of 3500 pa. Although the radiometric force does not tend to bring the parallel membranes together, it will be added here to the Van der Waals contribution in order to get a rough order of magnitude of the pressure. Thus we will assume that a total pressure of 6500 pa is applied to the lattice.

According to the book: “Microsystem Design,” by Stephen D. Senturia, Boston, 2001, the bending of a pressure loaded, doubly clamped beam is governed by the equation:

$${P}_{b} = ( \frac{{π}^{2} {σ}_{0} θ}{{b}^{2}} + \frac{{π}^{4} E {θ}^{3}}{3 {b}^{4}} ) c + \frac{{π}^{4} E θ}{4 {b}^{4}} {c}^{3} \qquad [ 14 ]$$

Where P_{b} is the total pressure exerted over the beam;
σ₀ is the residual stress of the beam after deposition;
E is the Young modulus of the material; and,
c is the linear bending at the center.

For silicon carbide E≈300 Gpa and σ₀≈300 Mpa. For P_{b}=6.5 Kpa, θ=30 nm, w=70 nm and c=1 nm, one solves the equation for b and finds b≈4.0 μm. If a bending as large as c=5 nm is tolerated (which is half the thickness of the gap), one finds b≈8.8 μm. Thus, the radiometric plate must be fragmented in small free-standing surfaces, the side of each individual surface being theoretically of the order of few micrometers. Thick structures like anchors and/or crossing struts must be put at the ends of the free standing plates to render the structure stable. It is understood, that if the thickness of the radiometric plate or the thickness of the individual membranes is increased, the length b of the free-standing surfaces can be increased consequently. The literature offers many examples of free standing beams and membranes similar to the ones discussed here. The following article is quoted as a model: “Fatigue Studies Of Nanoscale Structures For MEMS/NEMS Applications Using Nanoindentation Techniques”, by Xiadong Li, et.al. in Surf. Coat. Tech,. 163, 521 (2003). The article discloses that silicon beams 6 μm long, 225 nm high, and 400 nm wide were shown to withstand loads at the center larger than 0.1 mN.

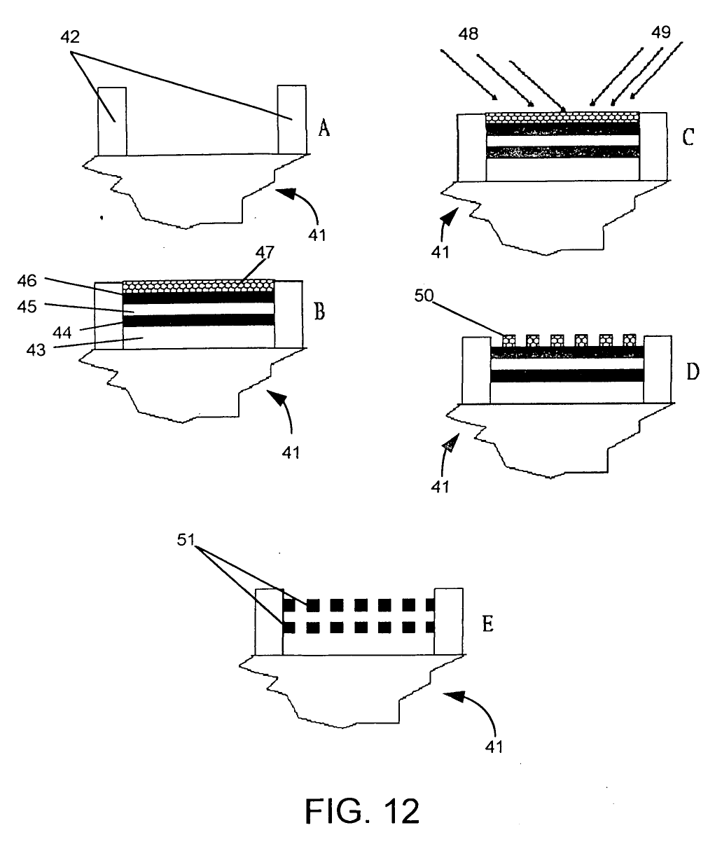

The fabrication of the parallel, perforated membranes suspended one above the other in the present invention, comprises a complex sequence of processes to be performed possibly in an integrated circuit laboratory and/or a micro and nanostructure laboratory. An exemplary process flow is shown in FIGS. 12A to 12E. One starts in FIG. 12A with a substrate 41 which can be silicon or any other material, and two anchors 42, which can be reinforcing struts, crossing beams, or any element necessary to the system like heat pumps or any element connected to them.

A sacrificial layer 43, which can be silicon dioxide (SiO₂) grown in an oven, is deposited on the substrate (FIG. 12B). Over this film a thin layer 44 of radiometric material like SiC is deposited by chemical vapor deposition (CVD) or any other technique suitable for thin film deposition. A second sacrificial layer 45 is deposited followed by a second film 46 made of radiometric material. Interference lithography can be used to pattern the holes. In this case a layer 47 of anti-reflection coating (ARC) and of resist is deposited on top of film 46. Achromatic interference lithography (as described in the articles: “Achromatic Holographic Lithography in the Deep UV” by E. H. Anderson, et al., J. Vac. Sci. Technol. B6, 216 (1988) and “An achromatic holographic configuration for 100 nm period lithography,” by A. Yen et al., Applied Optics, 31, 4540 (1992)) is then implemented (FIG. 12C). This sub-wavelength lithographic technique uses a laser which is split into two beams. The beams pass through a 200 nm grating and are focused on the substrate as shown in FIG. 12C. Here, the laser beams 48 and 49 interfere. The beams produce an interference pattern on the resist with a period that depends on the relative angle of incidence. After exposure, the resist is developed as shown in FIG. 12D. Here, the pattern 50 appears. The pattern is transferred to the films 44 and 46 by anisotropic etching. Finally, the sacrificial layers 43 and 45 are removed by etching using the holes as drain channels. One is left with two parallel, free standing perforated membranes 51 as shown in FIG. 12E. Ordinarily, the gap between the membranes is prone to diminish during the etching process, thereby causing the membranes to come together and adhere to one another. In order to prevent this, one could choose to deposit thicker films, 44 and 46. After etching of the sacrificial layers, 43 and 45, the films can then be ion milled down to the desired thickness.

Other techniques, different from interference lithography can be used. Alumina templates and Block-Copolymers (BCP) have the advantages of a high throughput, in other words, larger surfaces can be patterned in a shorter time and for less cost. With alumina templates the nano-holes self organize on a layer of amorphous alumina. If this technique is employed a smooth layer of aluminum should be deposited on top of layer 46 of FIG. 12B instead of the ARC and resist 47. The aluminum would then be anodized by immersion of the substrate in a solution of oxalic, sulfuric or phosphoric acid. Electrical contacts would be attached and a voltage applied. A self-organized hexagonal matrix of nano-pores would appear as a result of the current flow on the anodized aluminum (alumina). After removal from the solution and without need for radiation exposure, the alumina would be used directly as a mask to transfer the pattern to films 44 and 46. This can be accomplished for instance with reactive ion etch. The whole procedure is described in detail in the article: “Self-ordered pore structure of anodized aluminum on silicon and pattern transfer, by D. Crouse et al., Applied Physics Letters, 76, 49 (2000). The process described in this article can be used almost entirely in the present invention.

Block copolymer masks offer the advantage of a self assembled nano-hole structure that is produced without radiation exposure or immersion in acid baths. The drawbacks of pattern defects and irregularities typical of this technique, do not affect the present invention. Namely, a high degree of control of the shape and diameter of each individual hole is not required here. It is only necessary that the apertures have a certain average diameter and a certain average spacing. If BCP's are used as masks, the polymer should be spin cast over the film 46 in FIG. 12B instead of the ARC and the resist 47. The BPC will self assemble in a hexagonal matrix of holes with average diameter and spacing tunable by changes in the chemical composition of the BCP. The pattern is then transferred to the underlying films by reactive ion etching as described in the article: “Lithography with a mask of block copolymer microstructures, by C. Harrison et al., J. Vac. Sci. Technol B16(2), 544 (1998).”

The propulsion system of the present invention does not need motion of macroscopic components such as wheels or propellers to provide thrust. However, the maintenance of the temperature difference between the opposite surfaces of the radiometric plate requires a continuous supply of energy. If the power supply is interrupted, the conduction of heat will establish thermal equilibrium between the hot and the cold surfaces. Therefore, the present invention additionally comprises a power source and an efficient mechanism to deliver and remove heat where it is needed in the plate.

In a Crookes radiometer, the power is supplied by radiant energy. Heat is removed from the cold side of the vane by simple heat exchange with air. Therefore, the cold surface is hotter than room temperature, although it is colder than the hot surface. Other techniques are possible. In the vacuum pump disclosed in U.S. Pat. No. 6,533,554 (Stephen Vargo, Mar. 18, 2003) and mentioned above, power is supplied by means of a thin film electric heater deposited in the vicinity of the hot surface. These techniques would all be usable in the present invention. However, they would all need to dissipate large amounts of waste heat into air. This translates into a large power consumption.

In the preferred embodiment, the present invention utilizes a high efficiency electric heat pump. A heat pump has the advantage of recycling the waste heat removed from the cold surface to produce usable heat at the hot surface, thereby saving energy. The energy saved depends on the Coefficient of Performance (COP) of the pump which is defined as the ratio of the heat delivered by the heat pump at the hot surface to the power supplied. The higher the COP the lower the energy consumption. The theoretical limit of performance is given by the Carnot limit:
COP_{carnot}=T_{c}/(Tₕ−T_{c}).

The goal of the present invention is to provide a safe, silent, electrically powered propulsion system. Therefore, a solid state electric heat-pump, such as a thermoelectric Peltier cooler, is preferred here since it has no moving parts, It produces no noise, and does not require working fluids that pollute the environment. Thermoelectric Peltier coolers are devices known in the art to exploit the Peltier effect. Thermoelectric micro-coolers can be integrated directly on the radiometric plates during fabrication. This strategy shortens the thermal paths and eliminates parasitic temperature differences increasing the ability of maintaining usable temperature gradients. The heat pump must have the maximum available COP. The present invention can also use thermo-magnetic heat pumps exploiting the Ettinghausen cooling effect as described in the paragraph 1.5 of the book Thermoelectrics, Basic Principles and New Developments by G. S. Nolas, J. Sharp & H. J. Goldsmid, Berlin, 2001. Government and private research institutions are currently performing intense investigation of thermoelectric coolers because they show promise for replacing conventional, halocarbon-based refrigerators. This research is oriented toward development of low-dimensional thermoelectric materials such as nano-composites, superlattices, nano-based and nano-dot based coolers, skutterudites and quantum-well coolers. All these technologies can be used in the present invention. Electric coolers based on thermionic and thermo-tunnel diodes and converters can also be used in the present invention. These coolers are described, in part, in chapter 9 of the above mentioned book by G. S. Nolas et al. and are being investigated by General Atomics, Borealis Technical, Borealis Exploration, Gibraltar and Cool Chips PLC, a family of private companies fabricating diode based coolers that exploit quantum tunneling. Borealis claims efficiencies exceeding 55% of the Carnot limit. Currently, the most efficient microcoolers at room temperature use bismuth telluride/antimony telluride-based superlattices which approach a COP equal to 25% of the Camot Limit (see Nature, Vol. 413, p. 597, 2001).

In light of the available superlattice refrigeration technology it is expected that the radiometric propulsion system of the present invention will be highly efficient and be powered by batteries, fuel cells, grid power lines or other electric power sources.

### DETAILED DESCRIPTION OF THE VARIOUS EMBODIMENTS

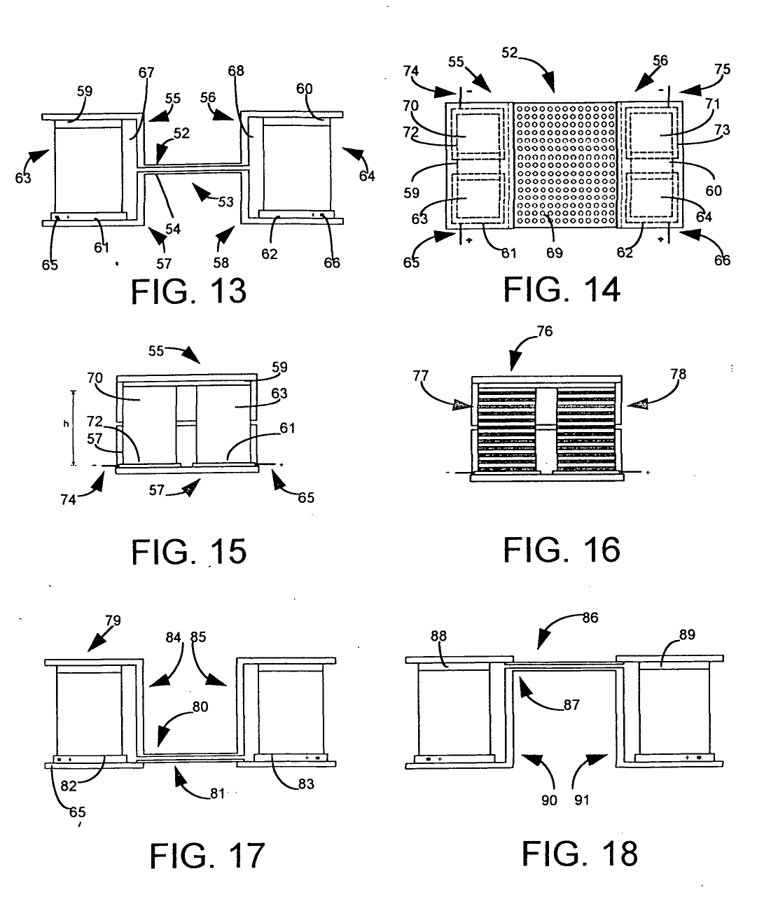

The basic features described above are employed in the present invention, i.e., an electric propulsion device, shown in different embodiments in FIGS. 13-39. Each embodiment comprises radiometric plates substantially similar to the ones already mentioned. That is, each of the individual embodiments comprises parallel, perforated membranes separated by an insulator which is preferably air. Each embodiment comprises electric heat pumps and a power source. The following first three embodiments are based upon a microscopic portion of the propulsion system which is possibly only a few micrometers wide and a few micrometers long. This portion is called a radiometric thruster. A multiplicity of thrusters may be connected to form a module of the desired scale as shown in the remaining 7 embodiments that follow. Unless otherwise specified, all the features of an individual thruster are to be repeated periodically over the surface of the entire engine. In this case, the electric heat pumps—or coolers—are intended to be part of a global circuit where all coolers are connected in series electrically and in parallel thermally and all thrusters are powered by a unique power source. In all circuits shown below the polarity indicated with + and − symbols is purely exemplary and can be reversed. Accordingly, the direction of the temperature gradient indicated in the following embodiments can be reversed by changing the polarity. In other words, the cold membranes can be hot and the hot membranes can be cold.

### First Embodiment

FIG. 13 shows a front view of a radiometric thruster. Here, a free standing radiometric plate comprises two parallel membranes 52 and 53 and an insulating layer 54 which is preferably the naturally occurring gas in which the device is immersed, for instance air at atmospheric pressure. The membranes are thermally connected by means of L-shaped plates 55, 56, 57 and 58 to the junctions 59, 60, 61 and 62 of two independent Peltier thermoelectric couples whose front legs 63 and 64 appear in this view. The Peltier couples work as solid-state electric heat-pumps, removing heat from the cold, upper membrane 52 and delivering it to the hot, lower membrane 53 at the expense of electric power. The Peltier couples (or coolers) maintain a temperature difference between 52 and 53. Voltage is applied to the coolers by means of wires. A cross section of the positively charged parts 65 and 66 of the wires appear in this view. The polarity can be reversed. Electric power sources connected to the Peltier couples are present but not shown here. In this drawing, the legs 63 and 64 are not part of the same electric circuit but they can be easily connected in series to be part of a single circuit. Elements 59 and 60 are the cold junctions of the coolers, while elements 61 and 62 are the hot junctions of the coolers. All junctions are made of a good electric and thermal conductor, such as a metal. The thickness of the junctions must be chosen as to minimize the contact resistance which would decrease the efficiency of the Peltier couples. The L-shaped plates 55, 56, 57 and 58 are made of a solid material with high thermal conductivity and high Young modulus (radiometric material). They are preferably made of the same material of the membranes 52 and 53. Were a metal, e.g., tungsten, or any other electrically conducting material to be chosen for the L-shaped plates, the plates would be separated from the junctions or other electrical contacts in the circuit by layers of electrically insulating material, e.g., silicon dioxide. The L-shaped plates are divided from the legs 63 and 64 by gaps 67 and 68 of thermally insulating material. The gaps can contain the same material of 54 and preferably contain the naturally surrounding gas (for instance air). The gaps 67 and 68 prevent the thruster from having large power losses through heat conduction between the vertical part of the L-shaped plates and the legs 63, 64.

The membranes 52, 53 are made of radiometric material, like for instance Silicon Carbide (SiC), Aluminum Nitride (Al N), or diamond-like carbon. The length of the suspended radiometric plate has to be chosen as to avoid plate fracture, as well as large membrane bending and membrane contact as discussed above.

The membranes are both perforated with a multiplicity of apertures as shown in FIG. 14. This is a top view of the thruster. The upper, cold membrane 52 is shown. It is perforated with apertures 69 which can have various shapes (not necessarily circular), orientation and spacing as discussed in above. The geometry of the aperture matrix can differ from the one shown in the drawing. For example, it can be a hexagonal matrix, or a disordered assembly of pores. The number of apertures is not necessarily the same as shown in the figure. Preferably, but not necessarily, the spacing is of the order of A, the mean free path of the surrounding gas, and the aperture diameter is also of the order of A. The holes 69 of membrane 52 may be aligned with the holes present on membrane 53, but this is not a necessary constraint. They must be aligned if the insulator 54 is not a gas. In this case the insulator 54 is perforated as well. Its apertures are aligned with the apertures of the membranes. Preferably, the thickness of the radiometric plate—intended as the sum of the thicknesses of the membranes 52 and 53 and the thickness of the insulating layer 54—is of the order of λ. This too is not a necessary constraint. The apertures on the membranes can have the shape of long parallel slits as is shown in FIG. 9.

FIG. 14 shows that each of the two independent thermocouples comprises a cold junction 59 (left) and 60 (right) and two legs: 63, 70 (left) and 64, 71 (right). Each leg rests on an independent, electrically conducting plate. The legs to the left, rest on plates 61 and 72, while the legs to the right rest on plates 62 and 73.

FIG. 15 is a left-side view of the thruster. Here, legs 63 and 70 rest on plates 61 and 72. Plates 61 and 72 represent the hot junction of the couple. They deliver heat to the L-shaped plate 57 which in turns delivers it to the lower membrane of the radiometric plate. Plates 61 and 72 are made of a good thermal and electrical conductor. They also work as electrical contacts to which the wires 65 and 74 and the power supply are attached. In FIG. 15, leg 63 is of the n-type and leg 70 is of the p-type. That means, one has an excess of negative carriers (electrons) and the other has an excess of positive carriers (holes) according to the physics of semiconductors. The height h of the legs 63, 70, 64 and 71 must be chosen as to optimize the efficiency of the coolers. However, h should not be much larger than the suspended length b of the radiometric plate as shown in FIG. 13. All other geometrical and physical parameters of the coolers should be chosen as to optimize efficiency and/or heat pumping capacity according to the principles of thermoelectric refrigeration and Peltier-couple design found in chapter 17 of the book: “Thermoelectric Materials and Devices,” by I. B. Cadoff & E. Miller, New York, 1960.

The thermoelectric coolers should be made of materials which allow for the maximum COP and heat pumping capacity preferably at room temperature. In particular a high Seebeck coefficient and a low thermal conductivity are desirable. The present invention may implement superlattice thermoelectric coolers made of several materials like for instance Si/Ge—, Si/SiGeC— or metal-based superlattices. Superlattices are known to the art. They comprise alternating layers of two different elements or alloys. Each individual layer can be as thin as few angstroms and needs to be deposited with special equipment as for instance a metal-organic reactor known to the art. Superlattices have the advantage of a low thermal conductivity, low electrical resistivity and a high Seebeck coefficient. One kind of superlattice implements Bi₂Te₃/Sb₂Te₃ as p-type material (see Nature, Vol. 413, p. 597, 2001). These are currently the most efficient superlattices at room temperature and they are the preferred superlattices to be integrated with the radiometric plates in the present invention as shown in FIG. 16. Here, a thruster 76 similar to the one described above, has legs 77 and 78 composed of superlattices. Preferably Leg 77 is a Bi₂Te₃/Sb₂Te₃ superlattice of the p-type, and leg 78 is a superlattice of the n-type, for instance (but not necessarily) a Bi₂Te₃/Bi₂Te_{2.83}Se_{0.17} superlattice as described in the above article in Nature. These very efficient coolers were developed by R. Venkatasubramanian. Specification and method for fabrication for these coolers are disclosed, in part, in U.S. Pat. Nos. 6,071,351; 6,300,150; 6,505,468 and 6,722,140 as well as in the above quoted article by R. Venkatasubramanian published in Nature and in the references therein. It is understood that any improvements of the existing superlattices as to efficiency, pumping capacity or economy of fabrication which are compatible with the present invention, and any improvement to the above mentioned patents are to be included in this invention.

In the first embodiment, a different configuration of the radiometric plate is shown in FIG. 17. Here, a radiometric thruster 79 is shown. The thruster has the same physical and geometrical properties of the one shown in FIG. 13. The only difference is in the location of the radiometric membranes 80 and 81, which in this configuration lie very close to the level of the hot junctions 82 and 83. The thermal circuit comprises only two L-shaped plates 84 and 85 which have a slightly different geometry when compared to the L-shaped plates shown in FIG. 13. The lower, L-shaped plates shown as elements 57 and 58 in FIG. 13 are absent in FIG. 17.

In FIG. 18 a different location for the radiometric plate is disclosed. Here, the perforated membranes 86 and 87 are positioned very close to the level of the cold junctions 88 and 89. The lower L-shaped plates 90 and 91 are longer. The upper L-shaped plates are absent. The variations shown in FIGS. 17 and 18 might reduce the time and difficulty involved in the fabrication while keeping the performance of the thruster approximately unchanged. It is understood that FIG. 17 and/or FIG. 18 can adopt superlattices or any high efficiency material for the legs of the Peltier couples as discussed above.

### Second Embodiment

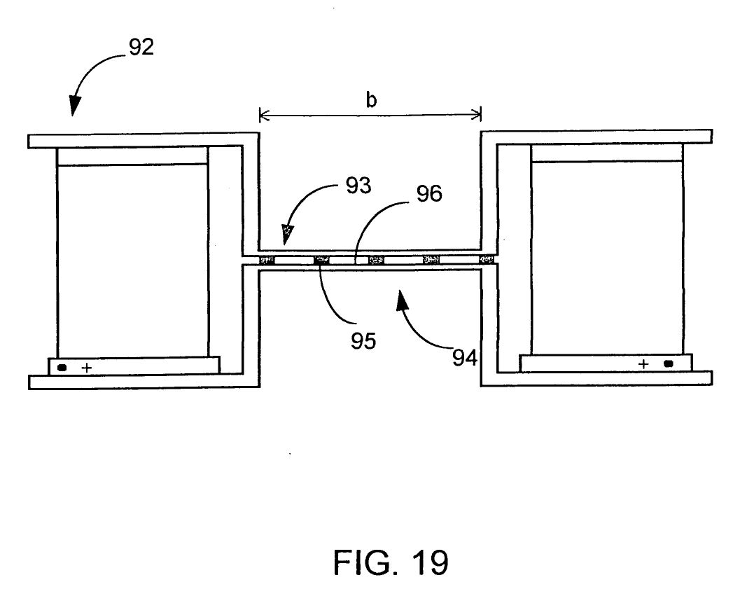

FIG. 19 shows the second embodiment of the present invention. It comprises a thruster 92 similar in the geometry, composition, and physics to the one of the first embodiment. The difference lies in the presence of a multiplicity of spacers 95 sandwiched between the radiometric membranes 93 and 94. The spacers 95 are made of a solid-state, thermal insulator. The voids 96 among the spacers are preferably filled with gas from the surrounding atmosphere. The spacers shown in 95 are not to scale, and a number of spacers different from the one shown may be sandwiched between the membranes 93 and 94. The spacers may have different shapes, cross sections, material composition and consistency. They can be made for instance of portions of thin, deposited films or they can be small irregular particles. They can have, spherical or nearly spherical shape. They can have an ordered or unordered distribution. They can have different aspect ratios than shown in the drawing. The spacers render the radiometric plate more stable. The membranes are less prone to bending. Therefore, the length b of the radiometric plate can be larger in this embodiment. Different possible locations for the membranes are possible as discussed in FIGS. 17 and 18. The physics and the materials of the coolers are identical to the ones discussed in the first embodiment.

### Third Embodiment

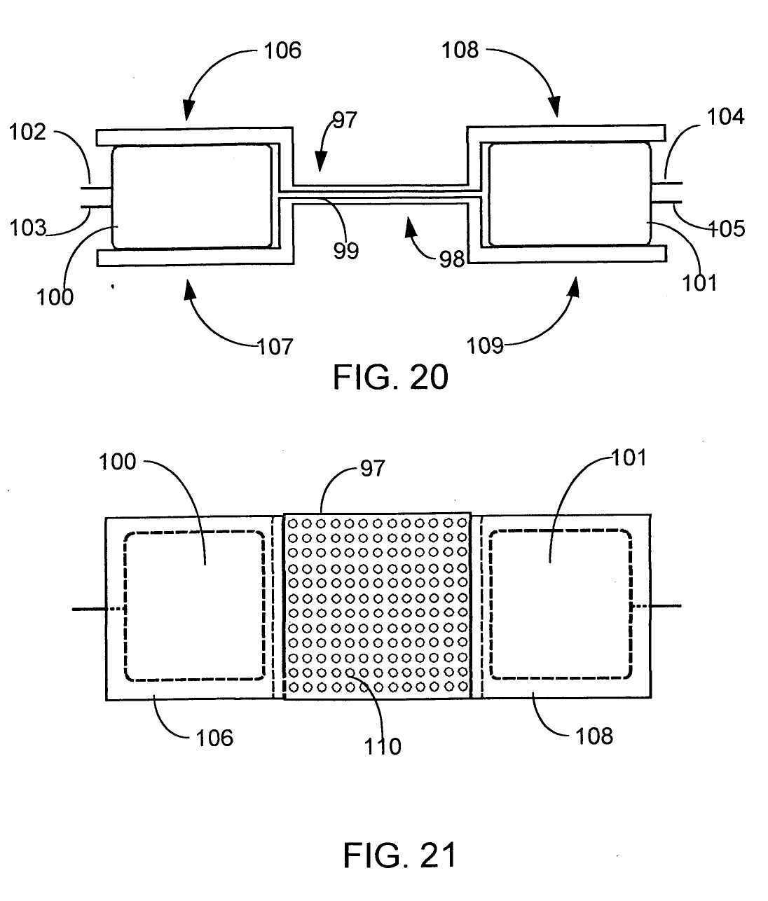

FIG. 20 shows a thruster comprising a radiometric plate with perforated membranes 97 and 98 insulating layer 99, and two coolers 100 and 101. These coolers exploit the thermionic and/or thermo-tunnel (or quantum-tunneling) effects. Such coolers may also be called thermionic/thermo-tunnelling diodes or thermionic/thermo-tunnel converters or diode heat pumps. They comprise a cathode and an anode separated by a small vacuum gap, a gas filled gap or a dielectric insulator. When voltage is applied to the cathode-anode pair (for instance by means of the contacts 102, 103 104 and 105 in FIG. 20), electrons evaporate off the cathode and/or quantum-tunnel through the gap taking kinetic energy away from the cathode. Consequently, the cathode cools and the anode heats up. The temperature difference that is generated by the diodes 100 and 101, is transmitted to the membranes 97 and 98 by means of thermally conducting plates 106, 107 and 108, 109 made possibly of radiometric material. Unlike Peltier coolers, diode heat pumps have the advantage of, small when none, heat losses through the solid material which composes the coolers. Therefore the efficiency or COP of these devices is high. Cooling devices of this kind are in a phase of experimental proof of concept at Cool Chips and Borealis Technical Limited, Gibraltar, and are disclosed in U.S. Pat. Nos. 6,064,137; 5,675,972; 5,699,668; 5,722,242; 5,810,980; 5,874,039; 5,981,071; 5,994,638; 6,089,311; 6,103,298; 6,117,344; 6,214,651; 6,281,139; 6,281,514; 6,417,060; 6,495,843; 6,531,703; 6,680,214; 6,720,704 and WO99/13562. A power source like a battery, fuel cells or power grid is included in this embodiment but not shown in the figure.

FIG. 21 shows a top view of this embodiment. Here, the top membrane 97 is shown with its pattern of apertures 110. All the remarks about the apertures made in the previous embodiments apply here. It is understood that the present embodiment can adopt spacers of any kind between the radiometric membranes as in the previous embodiment.

### Fourth Embodiment

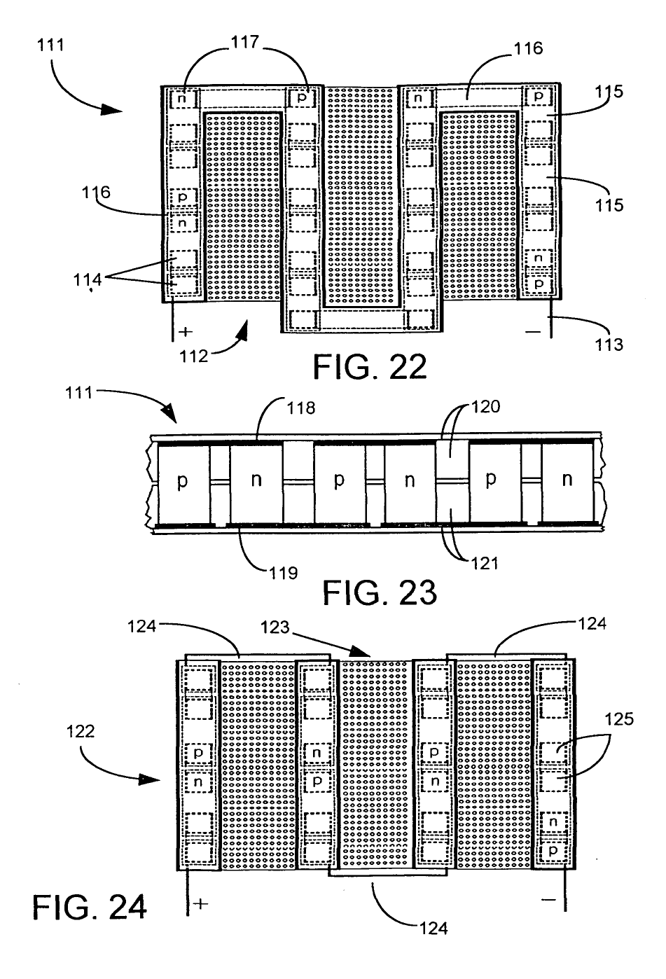

FIG. 22 shows a top view of this embodiment. a radiometric module 111, is the result of the assembly of a multiplicity of thrusters as the one shown in FIG. 14. The thrusters are connected in series electrically and in parallel thermally. The module 111 in FIG. 22 comprises a large radiometric plate 112 whose top perforated membrane is visible. A multiplicity of Peltier couples 114 are aligned and connected in series by means of a multiplicity of electrically conductive junctions in a way known to the art. The circuit comprises a multiplicity of hot junctions 115 and cold junctions 116 connected in series. P-type and n-type legs alternate along the circuit. Voltage is applied to the couples from a power source not shown in the drawing. The power source is connected to the ends 113 of the circuit. In FIG. 22 the cold and hot junctions are covered by upper and lower L-shaped plates as in the previous embodiments. A partial front view of this embodiment would look very similar to FIG. 13. The L-shaped plates are in contact with the junctions and with the radiometric membranes. They transmit heat from the junctions to the radiometric membranes. The module 111 comprises Peltier couples 117 positioned transversally with respect to couples 114. The couples 117 can differ slightly from the geometry of couples 114. A portion of the radiometric module 111 is enlarged and view from the left in FIG. 23. Here, the junctions 118 (cold) and 119 (hot) are shown. They appear in black to enhance contrast. The upper L-shaped plate 120 and the lower L-shaped plate 121 are shown. They connect the junctions 118 and 119 to the radiometric plate. This view is the analog of FIG. 15. The module 111 can extend—in principle—without limits along the axis given by the plane of the drawing in FIG. 22. In particular, the number of Peltier couples 114 and 117 and the surface of the radiometric plate 112 can be as large as required by the application of the propulsion system. All specifications regarding materials, geometry, efficiency and heat pump capacity of the coolers discussed in the first embodiment apply here. In particular superlattices of any kind can be implemented here. Different locations for the radiometric plate along the examples shown in FIGS. 17 and 18 are possible in this embodiment. Use of spacers—as shown in FIG. 19—is possible in this embodiment.

A slight modification of this embodiment is shown in FIG. 24. Here, a radiometric module 122 with radiometric plate 123 is shown. The transversal Peltier couples are absent. Simple electrical feedthoroughs 124 replace them closing the electrical circuit. The circuit comprises a multiplicity of Peltier couples 125. It is understood that the Peltier couples of this embodiment are build out of the same materials as the couples described in the first embodiment. In particular superlattices can be used. All the specifications of the coolers described in the first embodiments apply here. All configurations for the radiometric plate, including addition of spacers and positioning of the membranes at the level of the cold or hot junctions can be used here.

### Fifth Embodiment

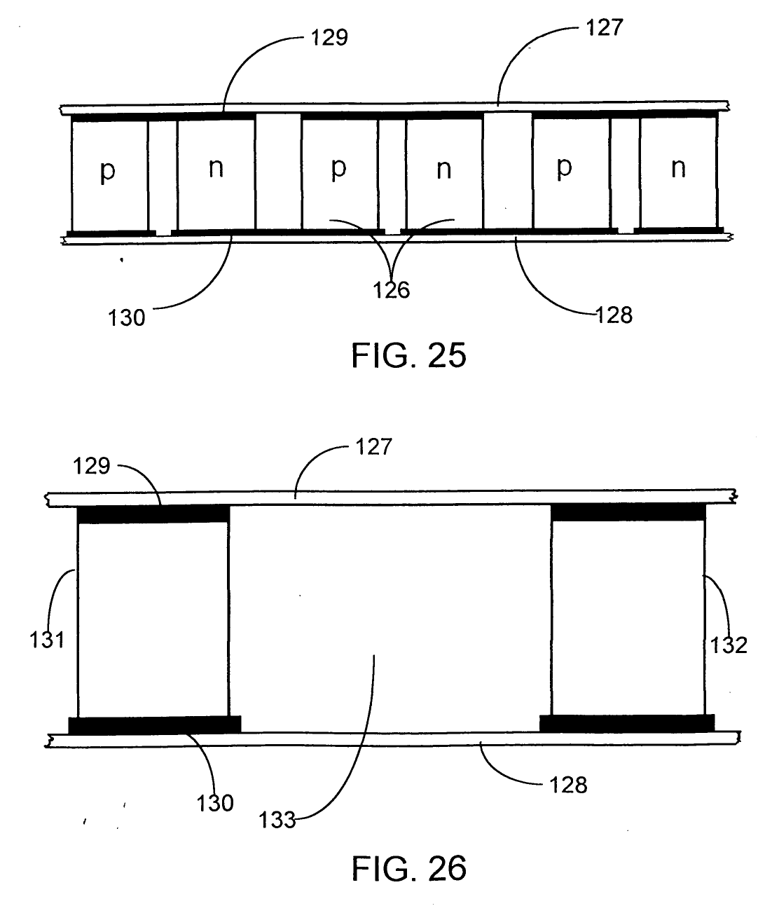

This embodiment comprises a radiometric module similar to the ones described above. However this embodiment does not have L-shaped plates as shown in FIG. 25. This is a left-side view of a portion of a radiometric module; FIG. 25 is the analog of FIG. 23. In FIG. 25 the thermo-electric Peltier couples 126 are directly sandwiched between the cold radiometric membrane 127 and the hot radiometric membrane 128. The L-shaped plates are absent. The cold junctions 129 and hot junctions 130 are in direct contact with the membranes 127 and 128 respectively. The junctions are shown in black in the figure. The junctions directly supply heat to the hot membrane and remove heat from cold membrane. As in FIG. 23, the interstices between the coolers can be filled with gas from the surrounding atmosphere or with a thermal insulator of a different kind. A frontal section of this module is given in FIG. 26. Here, it appears more clearly that the coolers are sandwiched between the membranes of the radiometric plate. In FIG. 26, the upper, radiometric membrane 127 rests on top of cold junctions 129 and of legs 131, 132. The lower radiometric membrane 128 is attached to hot junctions 130 and to legs 131, 132. The membranes 127 and 128 shown in FIG. 26 are perforated with a matrix of apertures identical to the ones described in the first embodiment. The apertures are only present in regions of membranes 127 and 128 which do not overlap the junctions. In principle, the whole surface of membranes 127 and 128 could be perforated. However, the portions of the membrane overlapping the junctions 129 and 130 would be obstructed and would not contribute to the radiometric thrust. In FIG. 26, the gap 133 between the membranes 127 and 128 is filled with gas from the surrounding atmosphere or with a different thermal insulator.

This embodiment is simpler to fabricate due to the absence of the L-shaped plates. Also the radiometric membranes can tolerate a larger bending in this embodiment.

This embodiment is preferable in case legs 131 and 132 can be made short without reducing drastically the efficiency of the Peltier couples. More generally, when thin coolers can be sandwiched between the radiometric membranes, this embodiment can be the optimal choice. The thickness of the radiometric plate in this embodiment can be larger than the order of A. In this case the radiometric thrust may be smaller than the maximum thrust predicted by the theory. A loss of thrust can be acceptable if compensated by simplicity of design and economy of fabrication.

### Sixth Embodiment

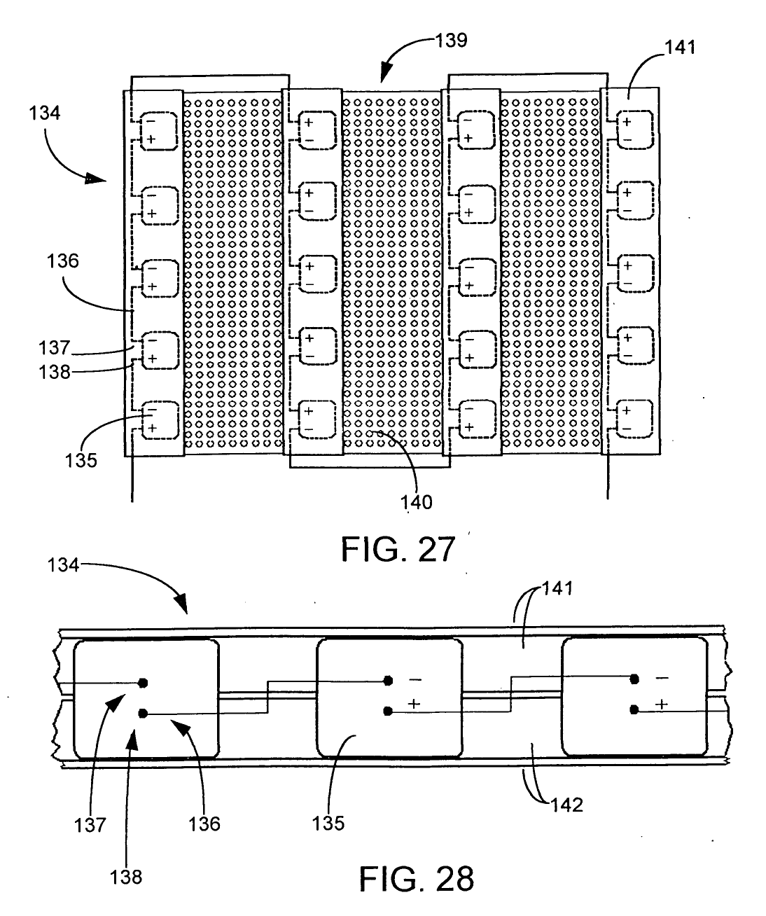

This embodiment is shown in FIG. 27. Here, a radiometric module 134 comprises a multiplicity of assembled thrusters like the one shown in FIG. 21. The module 134 maintains the temperature difference by means of a multiplicity of thermionic/thermo-tunnel diodes 135 connected in series electrically by means of wiring 136. In each diode the electrical contacts 137 and 138 appear in a slightly different geometry with respect to contacts 102 and 103 of FIG. 20. This is just for sake of clarity of the drawing. The module 134 has a radiometric plate 139 similar to the one shown in FIG. 22. Only the upper membrane of the radiometric plate is visible. This membrane is perforated with apertures 140. As it is clear, the apertures 140 are not necessarily to scale with the rest of the drawing and they may have a different size, shape, spacing and matrix geometry. The diodes 135 are covered by a series of L-shaped plates 141 which are made of a good thermal conductor with high Young modulus and they are possibly made from a radiometric material An enlarged, partial view from the left of this embodiment is given in FIG. 28. Here, a portion of the module 134 appears along with diodes 135, the electrical contacts 137, 138 and the wiring 136. The upper L-shaped plate 141 and the lower L-shaped plate 142 are visible. The upper L-shaped plate 141 thermally connects the cold surface of the diodes to the cold membrane of the radiometric plate. The lower L-shaped plate 142 thermally connects the hot surface of the diodes with the hot membrane of the radiometric plates. The radiometric membranes are not visible in FIG. 28. All the features of the diodes described in the third embodiment apply here.

### Seventh Embodiment

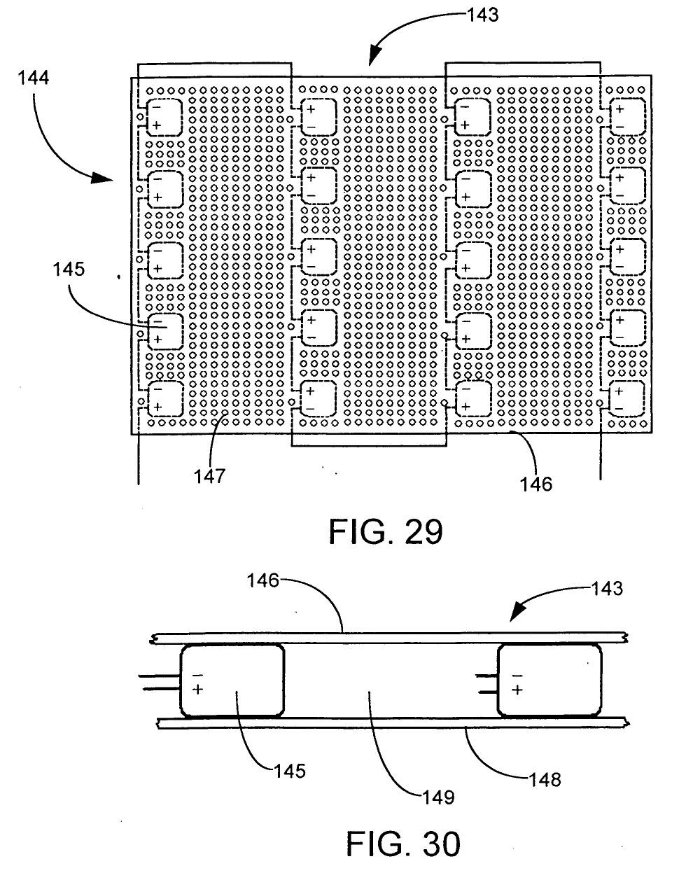

This embodiment is shown in FIG. 29. Here, a radiometric module 143 comprises a radiometric plate 144, and a multiplicity of thermionic/thermo-tunneling cooling diodes 145 connected in series electrically and in parallel thermally. As in the previous embodiments, the radiometric plate 144 comprises two perforated membranes, and an insulator which consist preferably of natural occurring gas from the surrounding atmosphere. Unlike the sixth embodiment, the L-shaped plates are absent. The upper perforated membrane 146 is visible in FIG. 29, it is perforated with a multiplicity of apertures 147. The membranes are perforated over their entire surface except in the regions of the membranes overlapping the cooling diodes 145. A Front view of this embodiment is partially shown in FIG. 30. Here, the upper and lower perforated membranes 146 and 148 are visible. The cooling diodes 145 are sandwiched between these membranes. Therefore, in this embodiment the coolers are a part of the radiometric plate 143. The gap 149 between the membranes 146 and 148 is filled with an insulator such us air. If one compares FIG. 30 with FIG. 20 one sees that in the former the coolers are in direct contact with the membranes while in the latter the heat is transmitted by means of L-shaped, thermally conducting plates. As for the fifth embodiment, the embodiment shown in FIG. 30 would have the advantage of a simpler fabrication process and higher stability of the radiometric plate. This embodiment exploits the fact that, in principle, the cooling diodes can be very thin and therefore the membranes 146 and 148 can be very close if required. Namely, the heat pumping capacity of the cooling diodes is increased when the gap between the anode and the cathode is very small, of the order of few nanometers. The gap is typically a thin layer of gas or vacuum which would extend horizontally inside the coolers 145 in the geometry shown in FIG. 30. Therefore coolers 145 can be in principle very thin. All the remarks made in the previous embodiment regarding the materials of the radiometric plate, the diodes, and the geometry of the apertures apply in this embodiment.

### Eighth Embodiment

In this embodiment the radiometric modules of the types described above (fourth, fifth, sixth, and seventh embodiments) are reinforced with a multiplicity of crossing beams. The beams permit the radiometric propulsion system to be scaled up. In other words, crossing beams or struts permit building a propulsion system with a large enough surface area to provide propulsion for large and massive vehicles. Since the strength of the beams depends on the third power of their thickness, the beam thickness is the crucial factor for scaling-up the device. The beams are made from materials with a high Young modulus which are thermally stable and resistant against oxidation.

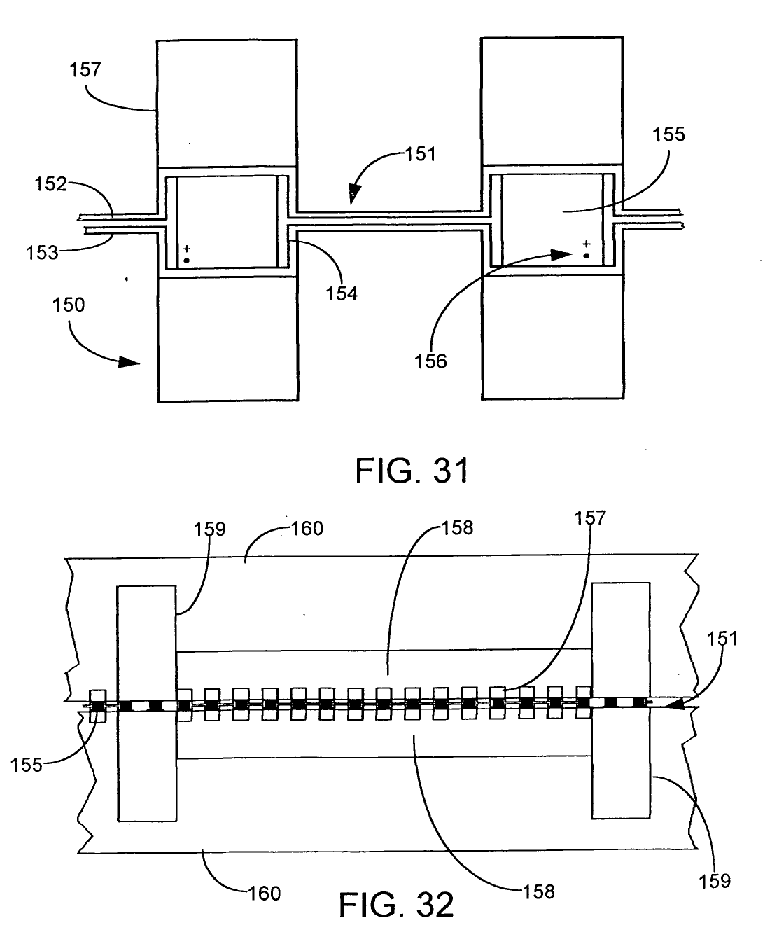

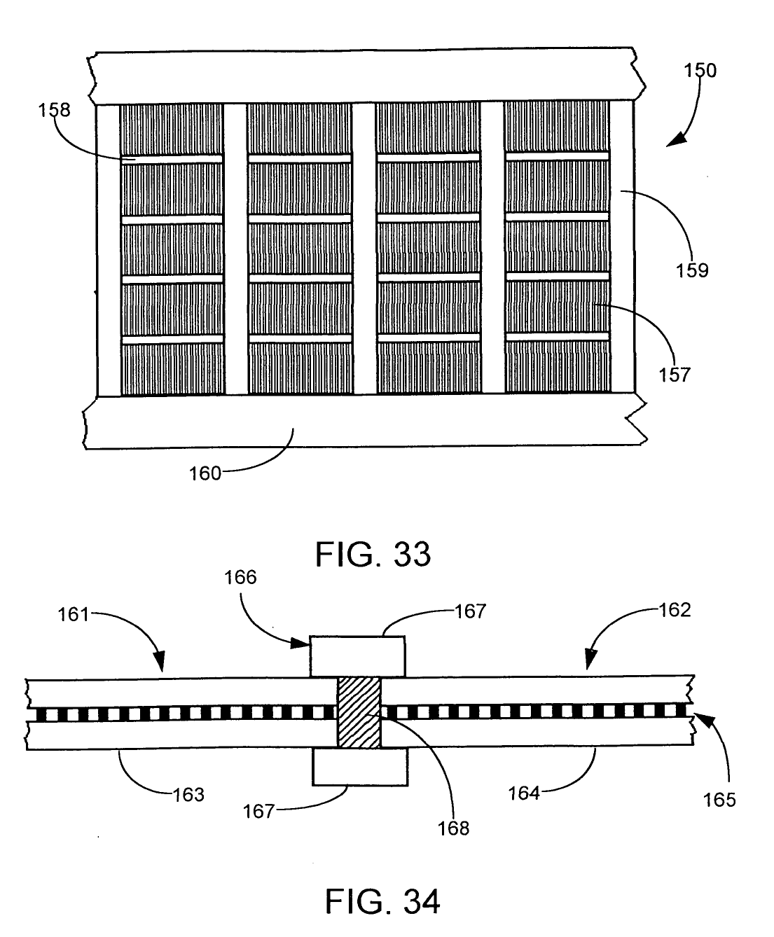

The beams can be fabricated in part, using chemical vapor deposition and/or electroplating combined with wet or dry etch known to the art. The eighth embodiment is partially shown in FIG. 31. This is a front view of a beam-reinforced radiometric module 150. A radiometric plate 151 comprises two parallel perforated membranes 152, 153 and L-shaped conducting plates 154. The module comprises a multiplicity of coolers 155. The coolers 155 are part of a global circuit. Each of the individual coolers 155 can comprise, for instance, a Peltier couple like the ones described above (comprising legs, junctions, electrical contacts and any other necessary component, and featuring high efficiency thermoelectric materials like superlattices) or it can comprise a thermionic/thermo-tunneling cooling diode as the ones described above. In the remainder of this document, coolers of the type 155 will be referred to as generic coolers. Whatever the nature of the cooling devices 155, they are connected in series electrically and in parallel thermally. In other words, they form a thermal circuit with the membranes 152, 153 and an electrical circuit with the wiring (generically represented here by elements 156) and the power supply. A multiplicity of beams 157 with arbitrary cross section (not necessarily rectangular as shown in the figure) are deposited above the cold and hot surfaces of the coolers. Beams 157 extend along the axis which is perpendicular to the plane of the drawing. The beam material has the properties described above. The thickness of the beam has to be chosen as to give the maximum rigidity to the structure. FIG. 31 shows a limited portion of the module. A larger portion is displayed in FIG. 32. Here, the radiometric plate 151 and the generic coolers 155 are shown in black to enhance the contrast with the beams which are shown in white throughout. Beams 157 are visible. A series of beams 158 perpendicular to beams 157 appear. Beams 158 are thicker and longer than beams 157. A further series of beams 159 stretches perpendicularly to beams 158 and parallel to beams 157, i.e. beams 159 extend along the axis which is perpendicular to the plane of the drawing. A series of crossing beams 160, perpendicular to beams 159 appears. The thickness of the beams increases with the beam length. It is to be noted, that the beams in the upper part of the module are not in direct contact with the beams in the lower part. Beams in the upper part should not exchange heat with beams in the lower part. In some regions of the device the coolers 155 can be sandwiched between beams 159 as shown in the figure. The radiometric plate can be absent in these regions since it would not contribute to the force. A top view of a larger portion of this device is shown in FIG. 33. Here, the module 150 is shown. The crossing beams 157, 158, 159 and 160 are shown as well. The details of the radiometric plate are too small to be displayed in this drawing. It is understood that more series of crossing struts with increasing thickness and length can be assembled in a way similar to the one described above. Any number of beams can be integrated in a reinforced radiometric module in a way similar to this embodiment. The structure shown in FIG. 33 must be rigid. Several modules similar the one shown in FIG. 33 can be assembled together. A possible method of assembly is shown in FIG. 34. This is a cross section of two arbitrarily reinforced radiometric modules 161 and 162 comprising beams 163 and 164 and generic coolers 165 shown in black to enhance the contrast. The coolers and the beams are not necessarily in scale. The radiometric plates are present but not shown here for simplicity. The modules are connected by an I-shaped element 166 comprising two compressing plates 167 and an insulator 168. The insulator 168 can be a gas or a solid like for instance silica aerogel. Aerogels are light solid materials with thermal conductivity comparable to air at atmospheric pressure.

### Ninth Embodiment

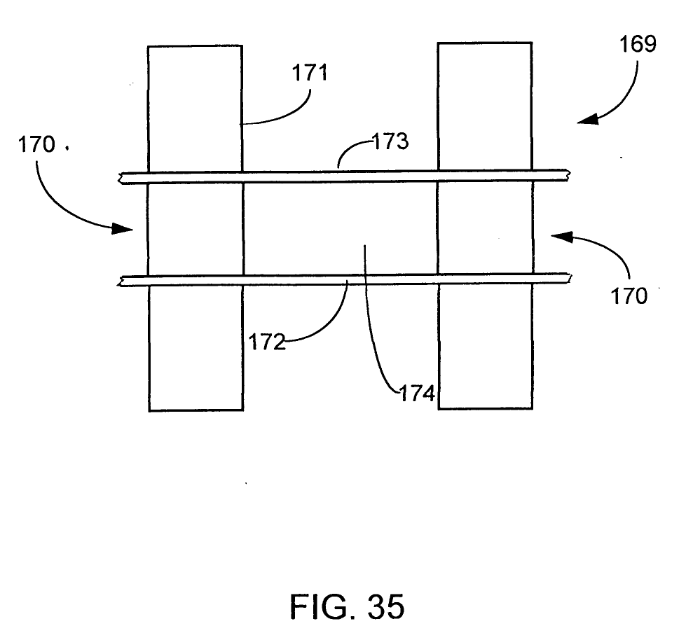

This embodiment comprises a beam-reinforced radiometric module identical to the previous. Only the geometry of the radiometric plate is different. In the ninth embodiment, the L-shaped plates are absent. The radiometric membranes are directly in contact with the hot and cold surfaces of the generic coolers. The generic coolers are sandwiched between the radiometric membranes in way similar to embodiments 5 and 7. Analogously to FIG. 31, FIG. 35 shows a partial front view of this embodiment. Here, a radiometric module 169 comprises a multiplicity of generic coolers 170 and reinforcing beams 171. Wiring for the coolers and power supply is not shown for simplicity. The coolers are sandwiched between two perforated membranes 172 and 173. An insulator 174, possibly air, fills the space between the membranes. The coolers 170 can be any kind of electric heat pumps as discussed above.

### Tenth Embodiment

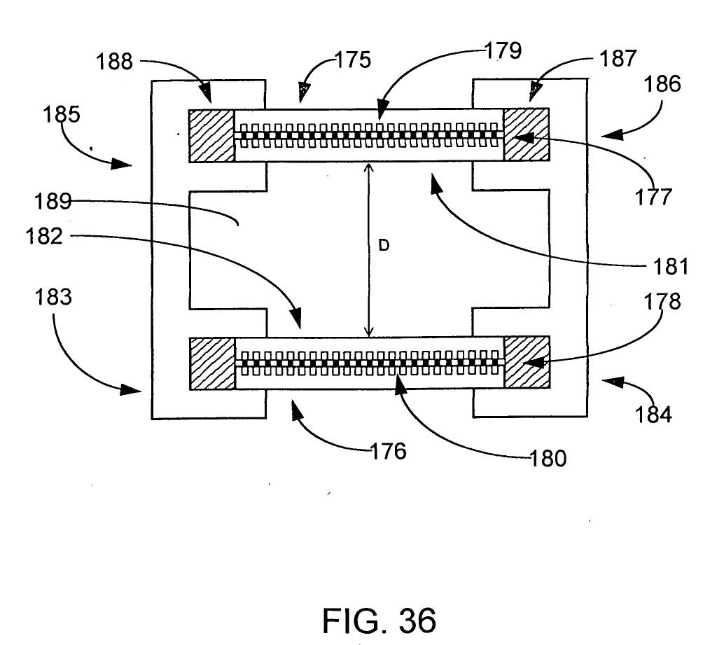

In this embodiment two or more radiometric modules of arbitrary type and size are stacked one above the other as shown in the exemplary drawing of FIG. 36. This is a frontal section of the embodiment. Two radiometric modules 175 and 176 (which may or may not be beam-reinforced) are shown. They have the same features of one or more of the embodiments 4, 5, 6, 7, 8 and 9 described above. In FIG. 36, two series of coolers 177 and 178—shown in black—are sandwiched between reinforcing beams 179, 180 and 181, 182. These beams are shown only as examples. More or less beams with different cross section, thickness and length can be present. The radiometric plates are present but not shown here to simplify the drawing. The modules 175 and 176 are stacked and held together by double-clamp-structures 183 and 184 which comprise robust rods 185 and 186 and insulating spacers 187, 188. The rods are made of a material which has a high Young modulus and a low thermal conductivity. The spacers 187, 188 are made of a good thermal insulator like a gas or preferably silicon aerogel. The gap 189 between the modules is filled with gas from the surrounding atmosphere, like air at atmospheric pressure. The distance D between the modules 175 and 176 has to be chosen as to minimize the disturbance of module 175 on module 176. In other words, if the modules are identical and the force generated by an individual module is F, the distance D has to be chosen as to allow the device shown in FIG. 36 to generate a total force as close as possible to the ideal value of 2F. It is understood that more than two radiometric modules can be stacked in a way similar to the one described above. A different arrangement of the rods, the spacers and the double-clamp-structures can be used.

Propulsion for a VTOL Vehicle

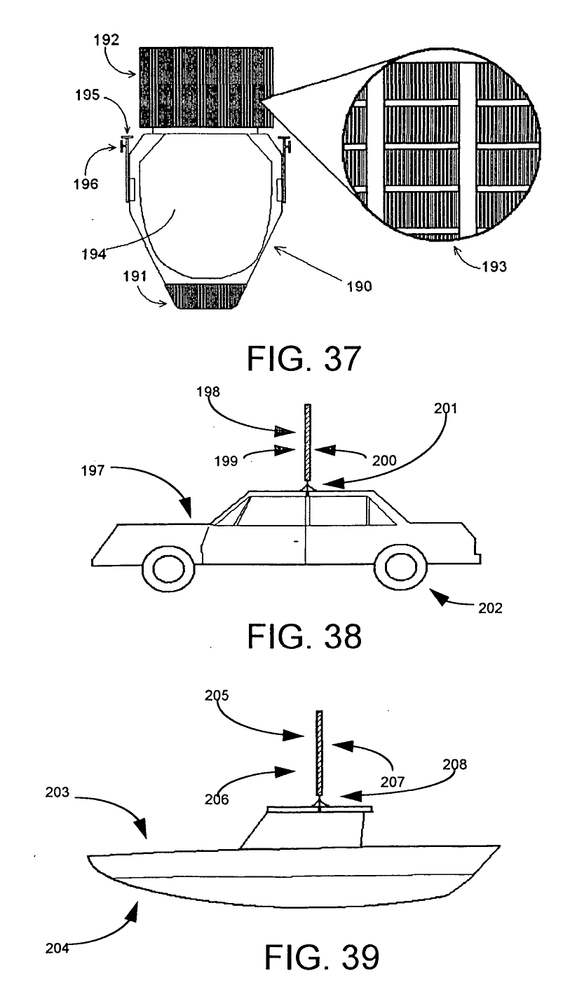

Embodiments 8, 9 and 10 show that radiometric modules can be reinforced and fabricated as large surfaces. Therefore, the radiometric propulsion system can provide propulsion to large devices and to lift massive vehicles. The vehicles that can be replaced using this propulsion system include helicopters and hydrofoils. An exemplary arrangement of the invention utilized in a Vertical Take Off and Landing (VTOL) vehicle is shown in FIG. 37. Here, a VTOL vehicle 190 is shown from top. The vehicle has a front reinforced radiometric module 191 and a rear reinforced radiometric module 192. The modules 191 and 192 are similar in the features to the modules described in the previous embodiments. A detail of the structure of the rear module is seen in the insert 193. This is the analog of FIG. 33. Reinforcing crossing beams are shown. The radiometric plate is present, but is not shown for simplicity. As described in the previous embodiments, the modules comprise generic coolers (of various possible nature) connected in series electrically and in parallel thermally. All the coolers present in the rear and front modules are part of a global electrical circuit. The circuit comprises a power source such as a battery or fuel cell stacks which is present in the vehicle but not shown in the drawing. The amount of thrust generated by modules 191 and 192 is controlled by changing the global voltage applied to the coolers. This can be done by the pilot located inside the vehicle cockpit 194.

The modules 191 and 192 provide vertical thrust directed perpendicular to the plane of the figure and protruding from the figure. For cruise motion, the vehicle is equipped with smaller radiometric modules 195 oriented perpendicular to module 192. Modules 195 are similar in their structure and physics to modules 191 and 192, but the temperature difference, that is the voltage applied to them, is not necessarily the same as in module 191 or 192. The cold membranes of modules 191 and 192 protrude from the figure. The cold membranes of modules 195 are directed toward the front of the vehicle. For changing the direction of motion, the vehicle is equipped with steering modules 196. The pilot applies a voltage to these modules only when a turn is necessary. Cruise motion and vehicle steering can also be provided by changing the inclination of modules 191 and/or 192. The modules 191 and 192 can be equipped with anti-dust filters. Filters would prevent dust particles, rain droplets and atmospheric moisture from clogging the apertures of the radiometric plates. Typically an individual moisture or dust particle is larger than 10 μm. Filters can comprise one or more gratings (possible having the same surface area as the modules) positioned above and/or below the modules. The gratings can have apertures which are orders of magnitude larger than the apertures of the radiometric plate. Anti-dust filters would be cleaned and/or replaced periodically.

Propulsion for a Ground Vehicle

The radiometric propulsion system can be used to provide thrust to a ground vehicle, e.g., an automobile or a truck. An exemplary arrangement is shown in FIG. 38. This is a side view of such a ground vehicle 197. The vehicle is equipped with a radiometric module 198 of arbitrary kind and surface. The cold side 199 of the module is directed toward the direction of motion, i.e., toward the front of the vehicle. The hot side 200 of the module is directed toward the rear of the vehicle. The module 198 can have any of the features described in the previous embodiments. It can be reinforced with beams or struts. It can comprise many modules stacked in series as described in the tenth embodiment. However, in this application the modules would be stacked along the horizontal axis of the figure.

The radiometric module 198 is solidly connected to the vehicle by means of element 201. The thrust generated by the module 198 is directly transmitted to the vehicle by means of element 201. No shafts or gears are necessary. Wheels 202 have a passive role in this vehicle. No engine is present under the hood. The vehicle 197 is equipped, for example, with DC batteries or fuel cell stacks connected to the module 198 by means of an electric circuit (not shown in the drawing). The circuit voltage and polarity can be changed by the driver of the vehicle. The vehicle is electrically operated. The direction of thrust and of motion can be reversed by changing the polarity. Reversal of polarity will cause the cold surface 199 to become hot and the hot surface 200 to become cold. Both the polarity and the temperature difference applied to radiometric module 198 can be rapidly changed by the pilot. Superlattice Peltier micro-coolers of the type described in the first embodiment and in the article published in Nature, vol. 413, p. 597, 2001, can achieve steady state cooling in few tenths of micro seconds. As discussed above the radiometric module 198 should have anti-dust filters. Since the wheels 201 are passive, the vehicle is less affected by the local conditions of the pavement and by slippage than conventional automobiles. The vehicle of the type shown in FIG. 38 can also comprise skis or blades instead of wheels 202. In this case the vehicle could easily move over surfaces covered by ice or snow.

Propulsion for a Floating Vehicle

The present invention, a radiometric propulsion system, can be implemented in a floating vehicle like the one shown in FIG. 39. Here, a boat or ship 203 having a hull 204 is shown. It is equipped with a radiometric propulsion system that comprises a radiometric module 205 similar to the ones described above. The module comprises a cold side 206 and a hot side 207. The direction of the temperature gradient is reversible. The module is connected to a power source like a battery or fuel cells present on board the vehicle. The module is transmits thrust to the vehicle 203 by means of element 208. This boat has the advantage of a completely dry propulsion system. In other words, no parts of the module are immersed in water. Thus the radiometric propulsion system is less prone to corrosion than conventional propeller-based boat propulsion systems. The propulsion system for this vehicle can have similar or identical features as the propulsion system for ground vehicles described above.

It is understood that the radiometric module can be positioned in different parts of the vehicle as long as the axis motion of the vehicle remains perpendicular to the radiometric plate.

Propulsion for a Submerged Vehicle

The present invention can be used for a vehicle that is immersed in a fluid medium that is more viscous than a standard atmosphere. Contemplated here are high pressure gaseous atmospheres or liquids. The design of the radiometric modules in these media depends upon the mean free path of the molecules. The mean free path, A, in such a medium is much smaller than for the gas molecules. This translates into a thinner plate and smaller apertures. However, given the limits of technology for fabrication of the radiometric modules, the use of a radiometric propulsion system for this application is reasonable.

In order for the concept of mean free path to be applicable to a liquid, the typical duration of a collision must be much smaller than the duration of the free flight. This is valid in gases where the time scale of a collision is so small that it can be neglected when compared to the time interval between two collisions. However, in a liquid, the time scale of collision is larger than the time scale of free motion. Therefore, the interaction between molecules is overwhelming, and the concept of free flight is meaningless. Therefore, if any radiometric effect is observable in liquids, the effect must be calculated using interaction potential theory (i.e., London-Van der Waals forces). One of the things that makes Einstein's theory of radiometric forces work is the fact that a gas is a compressible fluid. In other words, when you heat a region of the gas, this region becomes rarified, and when cooled the gas in this region becomes denser. This allows for gas to flow and for pressure to rise due uniquely to density variations. However a liquid is basically a non-compressible fluid. When a region of the liquid is heated, there are only minor variations in density. Boyle's Law (i.e., P=nkT) is not valid. Einstein's theory also does not apply.

However, if a small solid body is immersed in a solution of water and a solvent, the solid body will move when a temperature gradient is applied. The effect here is called thermophoresis. The thermophoretic mobility is due to the solvent ions suspended in water behaving much like a gas, and they exert a pressure on the body. However, if pure water is used, the effect disappears. (See Philosophical Magazine, 83 (17-18): 2199-2208, Jun. 11, 2003). It appears that the effect would not work in pure water. However, the effect would be present in salt water.

Specifically, for use in submarines immersed in water, the requirement of cooling the radiometric modules can be greatly reduced. Water has the ability to more easily remove the waste heat from the cold side of the module thereby making it easier to maintain the required temperature gradient.

Many submarines are powered by nuclear power. Submarine engines make the vehicle move through water using rotating propellers. Elimination of the propellers would permit silent movement of submarines. In addition, submarines currently move vertically through water using the principle of buoyancy. This requirement could be eliminated by the use of the radiometric propulsion system.

I claim:

1. A radiometric drive comprising:
at least one plate having two facial surfaces and at least one edge surface wherein each of the two facial surfaces are maintained at different temperatures such that a temperature gradient is established along an edge surface;
(a) wherein said plate is immersed in a fluid medium said medium being comprised of molecules; and,
(b) wherein the thickness of the plate is of the order of the mean free path of the molecules; and,
(c) wherein said plate comprises apertures therethrough; and,
(d) wherein the dimension of said apertures is of the order the mean free path of the molecules.

2. The radiometric drive of claim 1 wherein the fluid medium is a gas.

3. The radiometric drive of claim 2 wherein the gas is at approximately standard atmospheric temperature and pressure.

4. The radiometric drive of claim 2 wherein the gas is at approximately ambient temperature and pressure.

5. The radiometric drive of claim 1 wherein the average distance between the apertures is of the order of the mean free path of the molecules.

6. The radiometric drive of claim 1 wherein the open area of the apertures at a facial surface is equal to or less than one-half of the total area of said facial surface.

7. The radiometric drive of claim 1 wherein the apertures are arranged in a rectangular matrix.

8. The radiometric drive of claim 1 wherein the apertures are arranged to be hexagonally close packed.

9. The radiometric drive of claim 1 wherein the shape of the intersection of the apertures with a facial surface is circular.

10. The radiometric drive of claim 1 wherein the shape of the intersection of the apertures with a facial surface is rectangular.

11. The radiometric drive of claim 1 further comprising reinforcing members that render the plate or plates structurally stable.

12. The radiometric drive of claim 1 further comprising a power source for heating one or both facial surfaces of the plate.

13. The radiometric drive of claim 12 further comprising a heating element that heats the hotter facial surface and a cooling element that cools the colder facial surface.

14. The radiometric drive of claim 1 further comprising a heat pump that removes heat from the colder surface and recycles it to heat the hotter surface.

15. The radiometric drive of claim 1 wherein the plate comprises at least three layers, being a sandwich of two thermally conductive surfaces separated by a electrical and thermal insulating layer.

16. The radiometric drive of claim 15 wherein the electrical insulating layer is a gas.

17. The radiometric drive of claim 1 wherein the plate comprises at least three layers, being a sandwich of two thermally conductive facial surfaces at different temperatures, separated by a thermal insulating layer, one surface being a hotter surface and the other being a colder surface.

18. The radiometric drive of claim 17 wherein the thermal insulating layer is a gas.

19. The radiometric drive of claim 17 further comprising reinforcing members that render the plate or plates structurally stable.

20. The radiometric drive of claim 17 further comprising a power source for heating one or both facial surfaces of the plate.

21. The radiometric drive of claim 20 wherein the power source produces DC electric current.

22. The radiometric drive of claim 17 further comprising a heating element that heats the hotter facial surface and a cooling element that cools the colder facial surface.

23. The radiometric drive of claim 20 further comprising a heat pump that removes heat from the colder surface and recycles it to heat the hotter surface.

24. The radiometric drive of claim 23 wherein the heat pump is an electric heat pump.

25. The radiometric drive of claim 23 wherein the heat pump is a thermo-magnetic heat pump.

26. The radiometric drive of claim 23 wherein the heat pump comprises at least one theremoelectric cooler each having two legs and two junctions.

27. The radiometric drive of claim 26 wherein the legs of each thermoelectric cooler are fabricated from a material taken from the group consisting of nano-composites, superlattices, nano-wires, nano-dots, and skutterudites.

28. The radiometric drive of claim 23 wherein each cooler is a thermoelectric micro-cooler.

29. The radiometric drive of claim 28 wherein each micro-cooler is integrated directly on the radiometric plates during fabrication.

30. The radiometric drive of claim 26 wherein the thermoelectric cooler comprises at least one Peltier thermoelectric couple.

31. The radiometric drive of claim 30 wherein the facial surfaces are thermally connected by L-shaped plates to the junctions of two Peltier thermoelectric couples.

32. The radiometric drive of claim 30 wherein at least one thermoelectric couple is incorporated into the thermal insulating layer.

33. The radiometric drive of claim 17 wherein the thermal insulating layer comprises a plurality of solid spacers.

34. The radiometric drive of claim 24 wherein the heat pump comprises thermionic or thermo-tunnel diodes.

35. The radiometric drive of claim 34 wherein the diodes are incorporated into the thermal insulating layer.

36. The radiometric drive of claim 23 further comprising sets of reinforcing beams or struts to make the drive rigid and to prevent rupture or bending.

37. The radiometric drive of claim 36 wherein the beams of struts are arranged to cross each other.

38. A radiometric propulsion system comprising a plurality of drives of claim 37.

39. The radiometric propulsion system of claim 38 wherein the drives are electrically connected in series and thermally connected in parallel.

40. The radiometric propulsion system of claim 38 wherein the drives are stacked or piled up one above the other.

41. A vehicle propelled by a radiometric propulsion system using the radiometric drive of claim 1.

42. The vehicle of claim 41 wherein said vehicle is a vertical take-off and landing vehicle.

43. The vehicle of claim 41 wherein said vehicle is a ground vehicle having wheels to operate on a solid surface or having skids to operate on snow.

44. The vehicle of claim 41 wherein said vehicle is a floating vehicle.
